(19) United States
(12) Patent Application Publication
(10) Pub. No.: US 2024/0073465 A1
(43) Pub. Date: Feb. 29, 2024

(54) FINE-GRAINED RECOMMENDATION SYSTEMS

(71) Applicant: Box, Inc., Redwood City, CA (US)

(72) Inventors: James Francis LAVINE, Denver, NC (US); Benjamin John KUS, Alameda, CA (US)

(73) Assignee: Box, Inc., Redwood City, CA (US)

(21) Appl. No.: 17/823,938

(22) Filed: Aug. 31, 2022

(51) Int. Cl. H04N 21/25; H04N 21/258

(52) U.S. Cl. CPC H04N 21/252; H04N 21/25891

(57) ABSTRACT

A recommendation system integrated with a content management system (CMS). The CMS stores instances of shared content objects and coordinates user interactions by and between a plurality of CMS users. Shared content objects are divided into a plurality of portions, after which any user interactions over the various portions of the content object are observed and analyzed. User interest inferences are drawn from analysis of the observed user interactions taken user over respective particular portions of the content object. Based on the inferred user interests, fine-grained recommendations are formed and propagated. Some fine-grained recommendations refer to further content objects (e.g., content objects of different types). Some fine-grained recommendations are propagated to other CMS users (e.g., to a plurality of CMS users that are related in some way). The fine-grained recommendations refer to one or more specific portions of a content object as well as to the content object itself.

### TECHNICAL FIELD

This disclosure relates to computer-implemented recommendation systems, and more particularly to techniques for making and using fine-grained recommendation systems.

### BACKGROUND

Computer users have become accustomed to receiving recommendations from online service providers. For example, it is an everyday occurrence that a shopping site (e.g., Amazon.com) presents shopping “suggestions” or recommendations to a user. Such recommendations are user specific in the sense that the recommendations presented are derived based on specific observed activities that had been taken by that specific user. That is, a user who bought a bicycle helmet might receive a suggestion to also buy a helmet-mounted bicycle light.

Making such user-specific recommendations has proven to be so successful in the online shopping domain that computer engineers have attempted to deploy recommendation systems in other domains where receiving such recommendations is deemed to be of high value. Exceptionally high value can be realized when the recommendation system brings to the fore just a few recommendations (e.g., easy to display on an on-screen list or array) that are drawn from many hundreds or thousands (or more) potential recommendation candidates. To illustrate, consider that a particular user is associated with an observed pattern of streaming action films that include martial arts. It would be helpful to that user to receive recommendations of “Jackie Chan” films. It would be even more helpful to that user if the particular Jackie Chan movie recommendations did not include Jackie Chan movies that that particular user had already streamed. It would be even more helpful if the recommendation system could somehow serve as a “mind reader” so as to present recommendations that the user would deem to be particularly relevant.

Unfortunately, modern recommendation systems, even modern recommendation systems that are tailored for use in specific domains, are still deficient when it comes to producing user-specific and user-relevant recommendations. Therefore, what is needed is a technique or techniques that address the failure of legacy recommendation systems.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and in computer program products for fine-grained recommendation systems, which techniques advance the relevant technologies to address technological issues with legacy approaches. More specifically, the present disclosure describes techniques used in systems, methods, and in computer program products for generating fine-grained recommendations based on user interactions with files of a content management system. Certain embodiments are directed to technological solutions that consider the actual sub-parts of files and their corresponding locations when making recommendations.

The ordered combination of steps of the embodiments serve in the context of practical applications that perform steps for considering the actual sub-parts of content management system (CMS) objects and their corresponding locations when making recommendations. The disclosed techniques for considering the actual sub-parts of content objects and their corresponding locations when making recommendations overcome long-standing yet heretofore unsolved technological problems associated with legacy recommendation systems that fail to consider logical sub-parts of files when making recommendations that arise in the realm of computer systems.

Many of the herein-disclosed embodiments for considering the actual sub-parts of content objects and their corresponding locations when making recommendations are technological solutions pertaining to technological problems that arise in the hardware and software arts that underlie content management systems. Aspects of the present disclosure achieve performance and other improvements in peripheral technical fields including, but not limited to, human-machine interfaces and data tagging.

Some embodiments include a sequence of instructions that are stored on a non-transitory computer readable medium. Such a sequence of instructions, when stored in memory and executed by one or more processors, causes the one or more processors to perform a set of acts that consider the actual sub-parts of content objects and their corresponding locations when making recommendations.

Some embodiments include the aforementioned sequence of instructions that are stored in a memory, which memory is interfaced to one or more processors such that the one or more processors can execute the sequence of instructions to cause the one or more processors to implement acts for considering the actual sub-parts of content objects and their corresponding locations when making recommendations.

In various embodiments, any combinations of any of the above can be organized to perform any variation of acts for generating fine-grained recommendations based on user interactions with content objects of a content management system, and many such combinations of aspects of the above elements are contemplated.

Further details of aspects, objectives and advantages of the technological embodiments are described herein, and in the figures and claims.

### BRIEF DESCRIPTION OF THE DRAWINGS

The drawings described below are for illustration purposes only. The drawings are not intended to limit the scope of the present disclosure.

FIG. 1A1 and FIG. 1A2 exemplify recommendation systems that emit fine-grained recommendations based on user interactions, according to an embodiment.

FIG. 1B1 depicts an example fine-grained document labeling technique as used in systems that infer fine-grained recommendations based on user interactions with portions of a document, according to an embodiment.

FIG. 1B2 depicts an example streaming media scene breakdown as used in systems that infer fine-grained recommendations based on user interactions with streaming media, according to an embodiment.

FIG. 1B3 depicts an example feature-level breakdown as used in systems that infer fine-grained recommendations based on user interactions with an image, according to an embodiment.

FIG. 1B4 depicts an example range breakdown as used in systems that infer fine-grained recommendations based on user interactions with an audio file, according to an embodiment.

FIG. 1B5 depicts an example virtual whiteboard asset breakdown as used in systems that infer fine-grained recommendations based on user interactions in an online meeting, according to an embodiment.

FIG. 1B6 depicts an example list element breakdown as used in systems that infer fine-grained recommendations based on user interactions with structured data, according to an embodiment.

FIG. 1B7 depicts an example metaverse, according to an embodiment.

FIG. 1C1 presents a utility chart as used to define an optimal granularity level of fine-grained recommendations, according to an embodiment.

FIG. 1C2 presents a data structure to represent a user-specific fine-grained recommendation, according to an embodiment.

FIG. 2 presents an operation flow as used in systems that infer fine-grained recommendations based on user interactions within a content management system, according to an embodiment.

FIG. 3A presents a content management system that emits fine-grained recommendations based on user interactions with content objects, according to an embodiment.

FIG. 3B presents an example rule-based processing flow as used in systems that infer fine-grained recommendations based on user interactions within a content management system, according to an embodiment.

FIG. 3C presents an example recommendation delivery system, according to an embodiment.

FIG. 4 presents a location labeling technique as used in systems that infer fine-grained recommendations based on user interactions with content objects, according to an embodiment.

FIG. 5 presents a machine learning model as used in systems that infer fine-grained recommendations based on user interactions with content objects, according to an embodiment.

FIG. 6A, FIG. 6B, and FIG. 6C depict system components as arrangements of computing modules that are interconnected so as to implement certain of the herein-disclosed embodiments.

FIG. 7A and FIG. 7B present block diagrams of computer system architectures having components suitable for implementing embodiments of the present disclosure and/or for use in the herein-described environments.

### DETAILED DESCRIPTION

Aspects of the present disclosure solve problems associated with using computer systems to make recommendations. Some embodiments are directed to approaches for considering the actual sub-parts of content objects and their corresponding locations when making recommendations. The accompanying figures and discussions herein present example environments, systems, methods, and computer program products for generating fine-grained recommendations based on user interactions with content objects of a content management system.

### Overview

Recommendation systems can be tailored for deployment into a domain-specific settings. Such recommendation systems might produce superb coarse-grained recommendations when such recommendation systems are tuned for deployment into a domain-specific setting. However even such domain-specific recommendation systems fail to produce fine-grained recommendations based on fine-grained analysis. To illustrate, it might be that the reason “why” a particular user has a pattern of choosing and streaming certain types of films is because that particular user loves action scenes (e.g., involving martial arts contests). Moreover, it might be that the reason “why” a particular user has a pattern of choosing and streaming certain types of films is because that particular user loves martial arts scenes that take place in restaurants (e.g., Jackie Chan in the kitchen). If a recommendation system were able to obtain and consider fine-grained information (e.g., down to the detail that the particular user loves martial arts scenes that take place in restaurants), then the recommendation system could at least potentially offer a set of fine-grained recommendations, possibly limiting the set of fine-grained recommendations to only those martial arts films that indeed have fighting scenes in a restaurant.

Continuing this illustration, if a recommendation system were able to obtain and/or make inferences down to the detail that the particular user loves martial arts scenes that take place in restaurants, then the recommendation system could at least potentially offer a set of fine-grained recommendations down to the specific chapter(s) or scene(s) in a movie where the martial arts scene in a restaurant actually occur. Unfortunately, even the most modern recommendation systems fail to consider user-specific information that could greatly improve the inferences that go into making fine-grained recommendations.

Recommendation systems are often used in content management systems. In some implementations, intra-CMS recommendation systems make user-specific recommendations down to the content object level. However, what is needed is the ability to make recommendations down to the level of specific locations or portions of a subject content object.

Said differently, if a recommendation system were able to obtain and consider additional information pertaining to the user's specific interests, then the recommendation system could at least potentially offer a set of highly tailored, fine-grained recommendations, thereby avoiding spurious positives (e.g., recommendations that arise from coarse-grained observations) and/or providing recommendations that draw the user's attention to specific locations or portions of a subject content object.

Strictly as an example, if a streaming movie recommendation system were able to obtain and consider user-specific information pertaining to how the subject user accesses and/or dwells on martial arts scenes (e.g., rewinds to a particular scene, replays a scene over and over, seeks to a particular scene, etc.) that are set in restaurants, then the recommendation system could recommend not only the streaming movie title (e.g., “Jackie Chan Does Dallas”), but also, the recommendation system could recommend the specific chapter or chapters (e.g., “Chapter 2”, “Chapter 5”) of the streaming movie that includes a restaurant scene.

As another example, if a streaming movie recommendation system were able to obtain and consider fine-grained information pertaining to how the subject user accesses, locates and/or dwells on the portions of a contract document (e.g., uses “Find” to word search, etc.) that concerns “Indemnification and Warranty”), then the recommendation system could recommend the specific locations in the contract where provisions for “Indemnification and Warranty” can be found. In fact, a recommendation system might be integrated with a content management system such that the recommendation system informs its underlying file system as to how to open a contract-containing file system document (e.g., to execute an open operation and automatically scroll to the first occurring “Indemnification and Warranty” section).

Different domains have different use models, and each different use model has its own set of observable events. Such observable events can, singly and/or in combination with other observable events, be used as fine-grained signals that are in turn used by the recommendation system to produce fine-grained recommendations.

As used herein, a fine-grained recommendation refers to a suggestion (e.g., to a CMS user) to take action with respect to a particular location within a content object. A fine-grained recommendation is more granular than merely referring to a file or content object, and is less granular than referring to an atomic constituent (e.g., an ASCII character, or a pixel, or a phoneme, etc.) of a file or content object. Moreover, a fine-grained recommendation refers to a logical portion of one particular file rather than to a plurality or group of files. For example, if the aforementioned one particular file is a Microsoft WORD™ document, then a corresponding fine-grained recommendation might refer to chapter or section of the Microsoft WORD™ document. As another example, if the aforementioned one particular file is a movie file (e.g., an MPEG4 file), then a corresponding fine-grained recommendation might refer to scene offset (e.g., from the beginning of the movie portion of the movie file) or scene portion offset (e.g., from the beginning of the scene in the movie file).

Many of the illustrative examples found herein and in the figures are specific to an online collaboration system, however selection of the specific types of environments in which online collaboration systems are deployed in no way limits the generality of the disclosed techniques. In fact, various combinations of the disclosed techniques can be used in any environment, and/or pertaining to any type of computer objects and/or pertaining to any use model within which user behaviors can be observed.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to “some embodiments” or “other embodiments” refer to a particular feature, structure, material, or characteristic described in connection with the embodiments as being included in at least one embodiment. Thus, the appearance of the phrases “in some embodiments” or “in other embodiments” in various places throughout this specification are not necessarily referring to the same embodiment or embodiments. The disclosed embodiments are not intended to be limiting of the claims.

### Descriptions of Example Embodiments

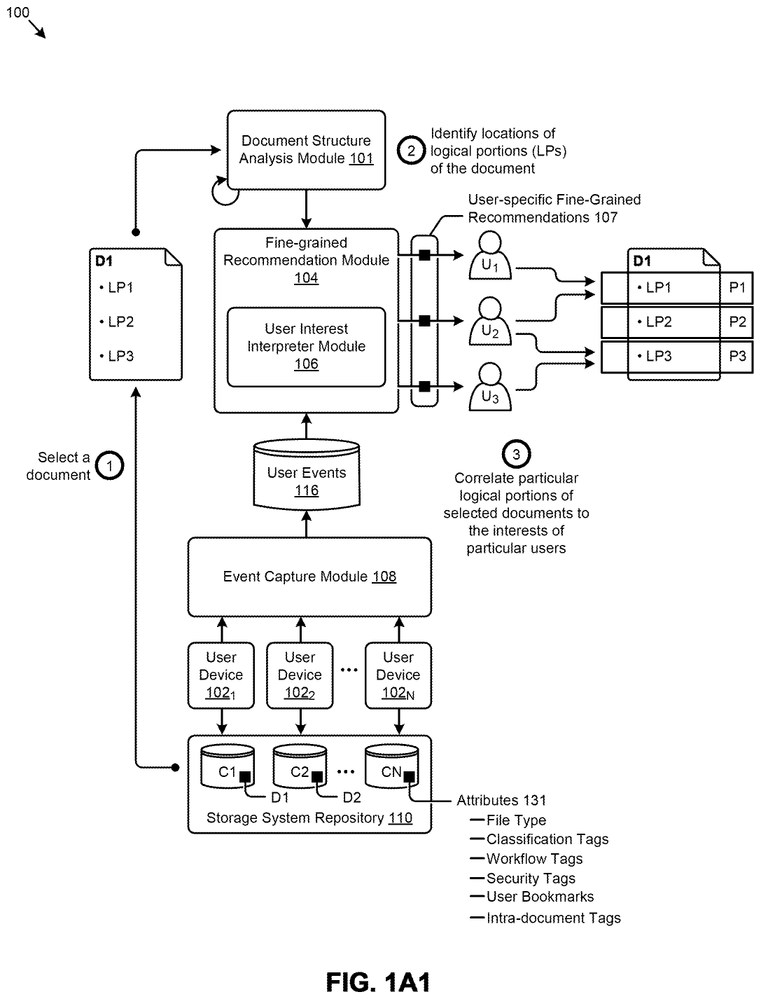

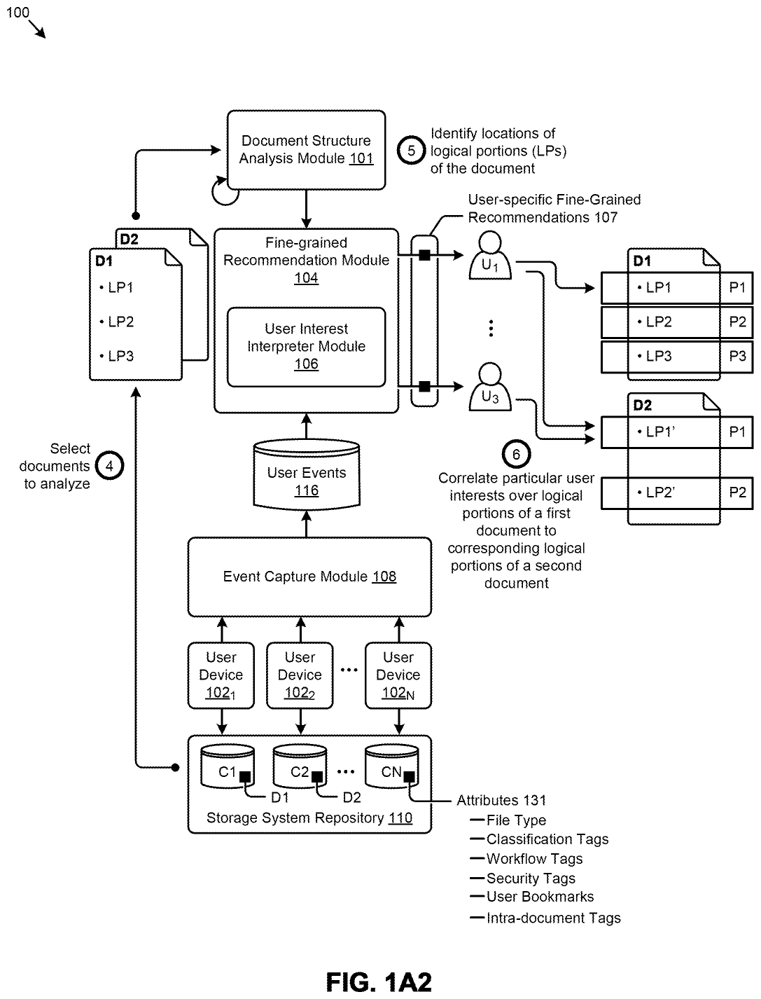

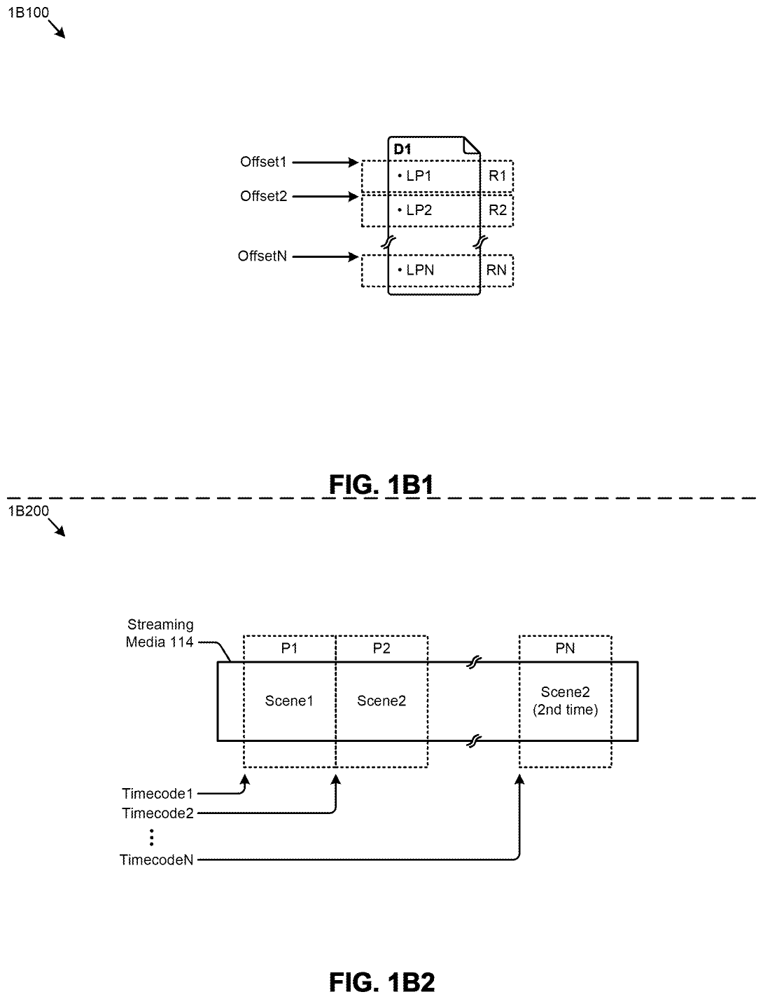

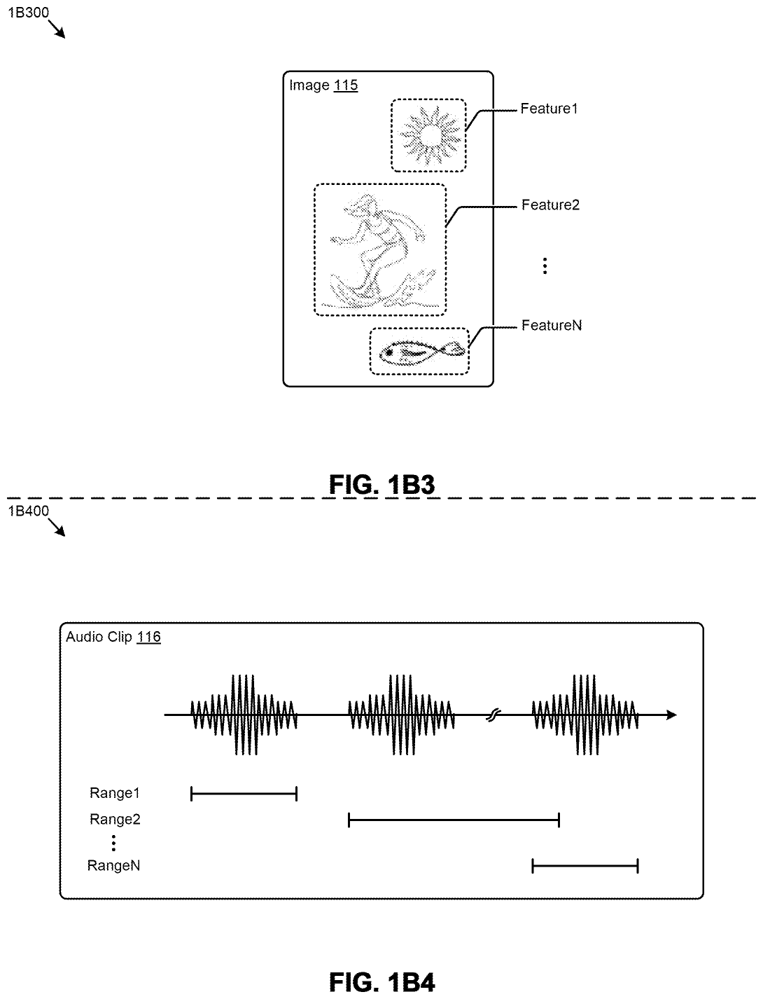

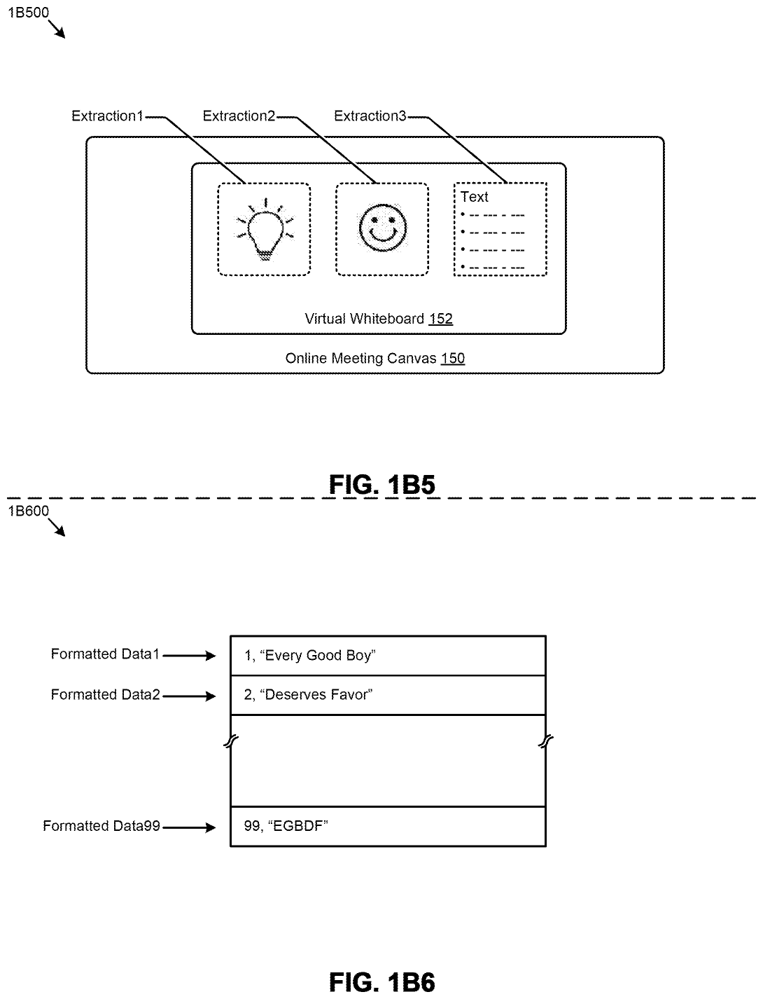

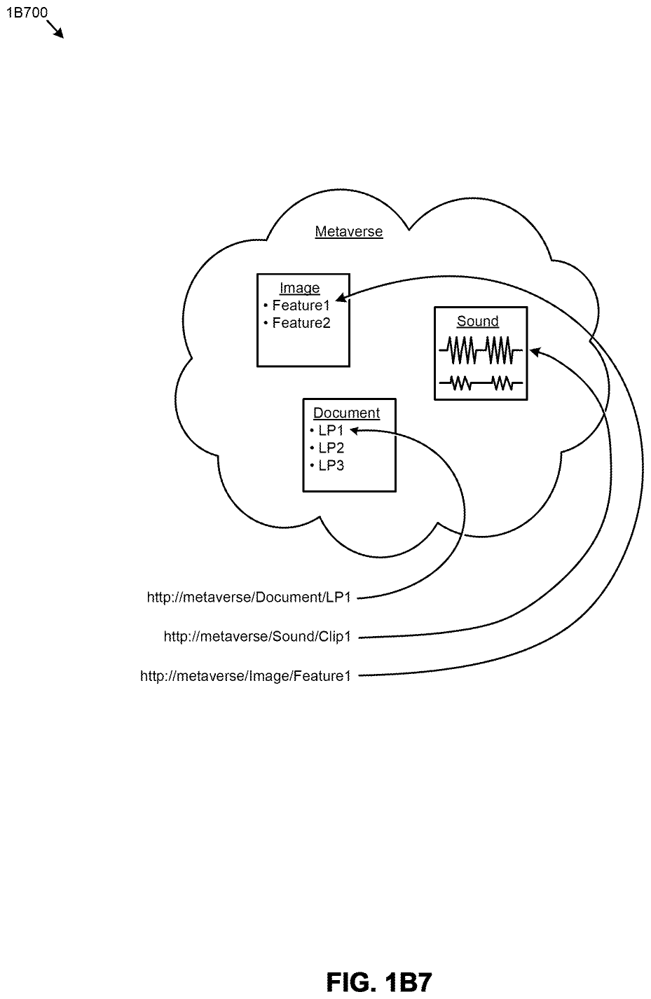

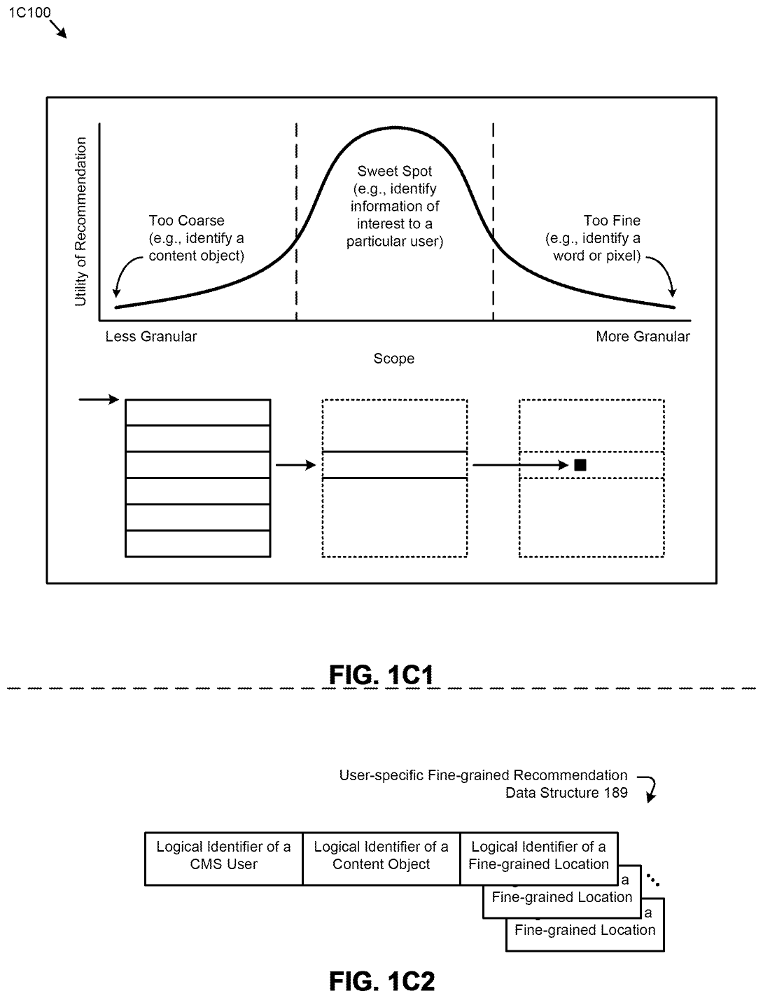

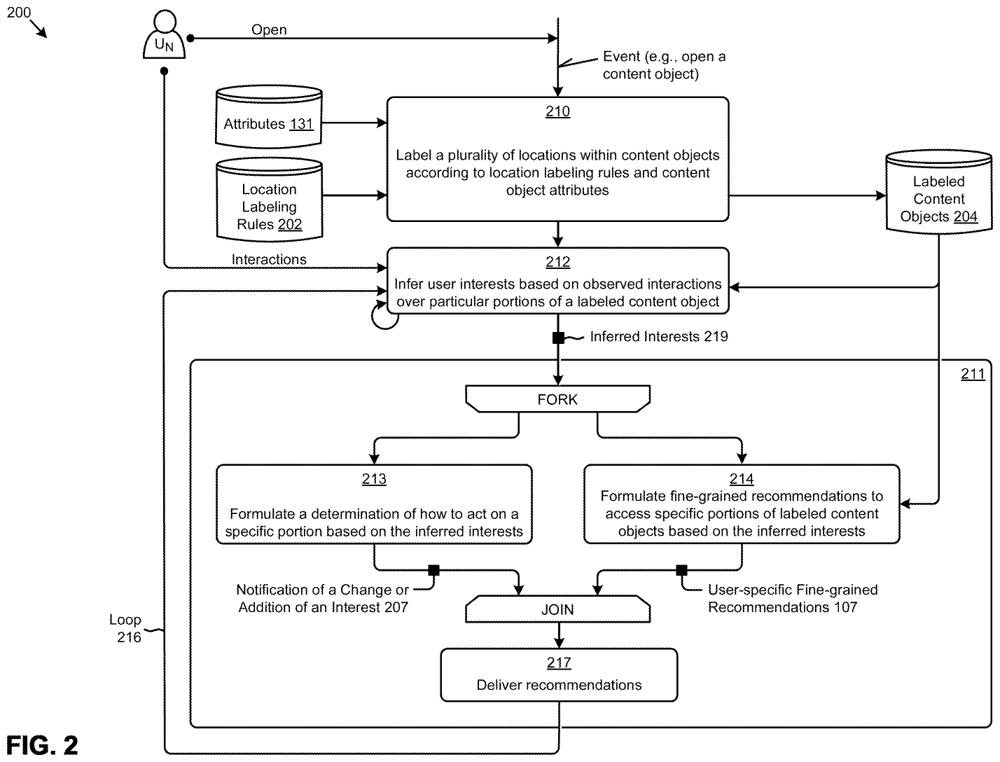

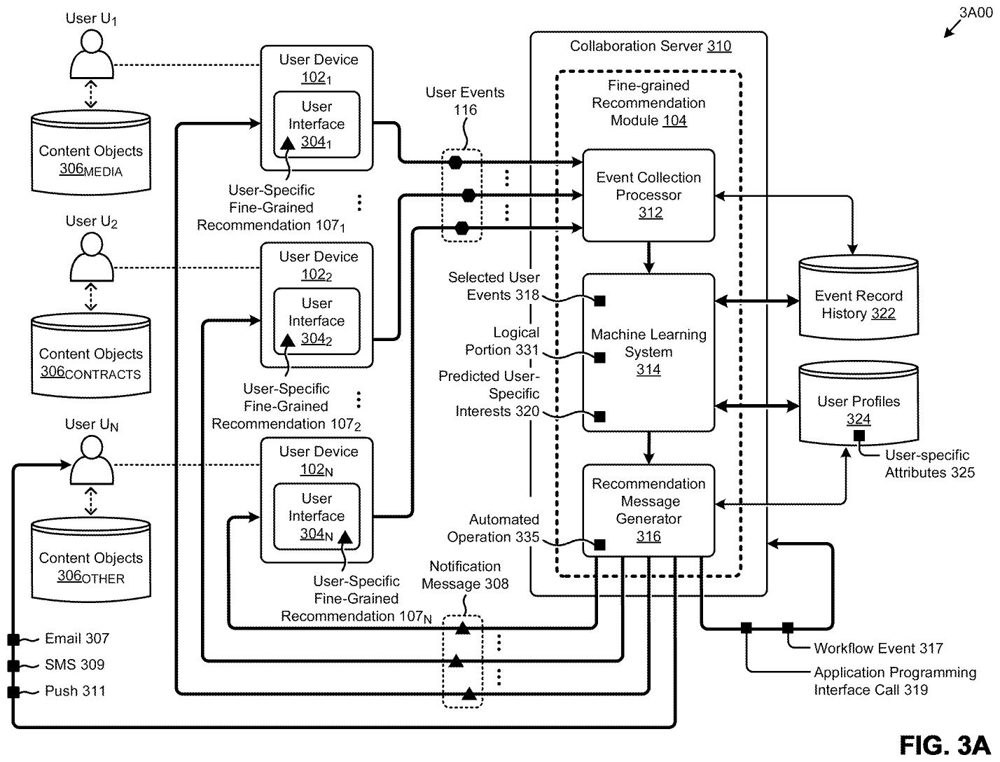

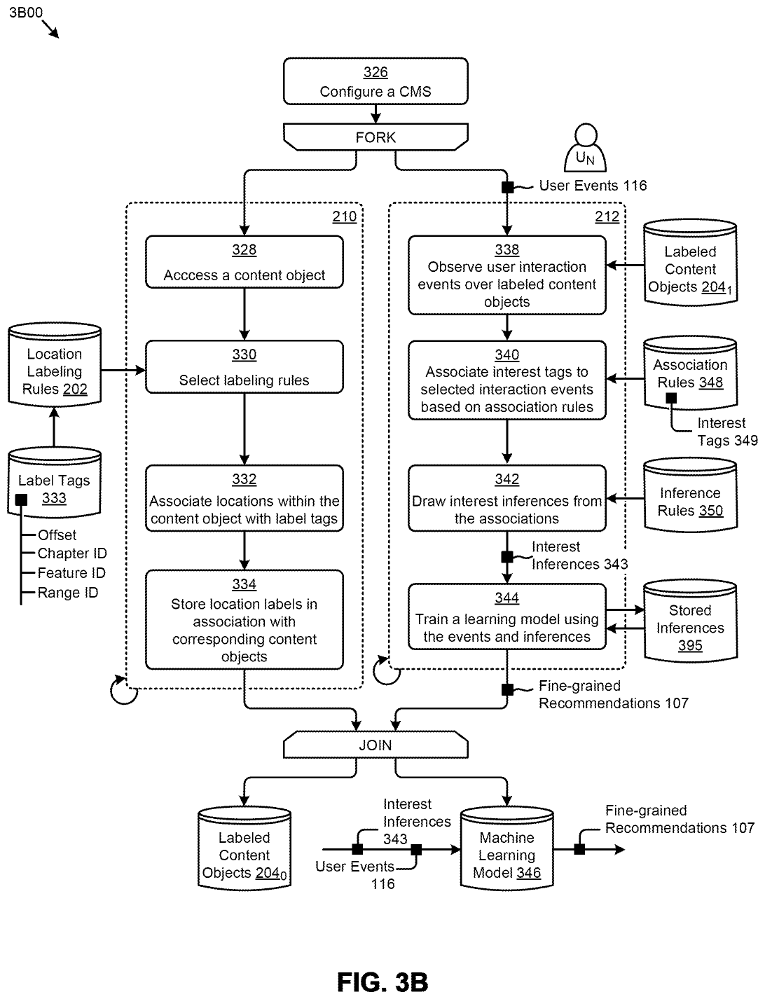

FIG. 1A1 exemplifies a recommendation system that emits fine-grained recommendations based on user interactions. As an option, one or more variations of recommendation system 100 or any aspect thereof may be implemented in the context of the architecture and functionality of the embodiments described herein and/or in any environment.

The figure is being presented to illustrate how a fine-grained recommendation module 104 can interpret user events over a labeled document to come up with fine-grained recommendations on a per-user, per-document basis. More particularly, the figure is being presented to offer an example of how different portions of a document can be correlated to different users' interests.

The shown flow corresponds to the scenario where (1) various content object corpora (e.g., corpus C1, corpus C2, . . . , corpus CN) are stored in a storage system repository 110; (2) a document D1 is selected from one of the corpora (operation 1); (3) logical portions of the document (e.g., logical portion LP1, logical portion LP2, logical portion LP3, of document D1) are identified and labeled (operation 2); and (3) specific portions of the selected document are correlated to specific users. In this embodiment, making fine-grained recommendations is facilitated by invoking a fine-grained recommendation module that distills user events into user interests, and then correlates the user's interests to specific logical portions of the selected document (operation 3). Once the various user's interests have been correlated to specific portions of the selected document, user-specific fine-grained recommendations 107 can be emitted to the various users. Subsequently, when one of the users logs into the system, the user-specific fine-grained recommendations pertaining to specific portions of specific documents can be presented to that particular user.

The foregoing acts taken over a particular corpus or over a particular document can be repeated any number of times over other corpora to generate a plurality of correlations between user interests and specific portions of a particular selected corpus or a particular selected document.

Strictly as one example flow through recommendation system 100, operation 1 might be configured to iteratively walk through the various corpora (e.g., corpus C1, corpus C2, . . . , corpus CN) and select particular documents (e.g., document D1) that are associated with particular content object attributes 131. In some cases, the selection of one or more particular documents can be based on one or more attributes such as classification tags, workflow tags, and/or security tags. In some cases the selection of one or more particular documents can be based on a combination of tags or attributes. For example, a process might iterate through the contents of the storage system repository 110 to identify only those documents that have, for example, both a workflow tag with a value equal to “Pending”, and a security tag with a value equal to “Secret”. The determination as to when to analyze documents can be subject to many different regimes. In one regime, analysis of a document so as to identify structural components, content boundaries, and/or locations of specific portions of the given document commences when the document is uploaded to the CMS.

The foregoing pertains to one particular regime, however a document can be brought into a CMS by any known means. Strictly as illustrative examples, a document can be brought into a CMS by its presence (e.g., as an attachment) in an email, or a document can be brought into a CMS by operation of a third-party application or web portal, or synched from an application that is integrated with the CMS.

Once a document or set of documents has been identified, the document or set of documents can be analyzed (e.g., via document structure analysis module 101) to identify structural components, content boundaries, and/or locations of specific portions of the given document or documents. Myriad specific techniques might be used to identify such locations of portions of the given document or documents. In fact, there may be many different applicable document analysis techniques that correspond to the various different types or attributes of documents. In exemplary cases, the identified locations and/or portions of a given document can be analyzed with respect to user events over the identified locations and/or portions of a given document. In this manner, user interest over the identified locations and/or portions of a given document can be inferred. Furthermore, aspects of inferred interest can be used to generate fine-grained recommendations.

In some embodiments, recommendation system 100 is interfaced to a content management system that stores instances of shared content objects and coordinates user interactions by and between a plurality of CMS users. Such content objects can be stored in the shown storage system repository 110 and/or in other storage facilities (e.g., in storage area networks, in cloud storage, in network attached storage, etc.). Assuming that certain modules of the recommendation system are given access—either via direct access or via indirect access—to content objects, where any of the content objects (e.g., the shown document D1) can be divided into a plurality of portions (e.g., the shown logical portion LP1, logical portion LP2, logical portion LP3). Such dividing operations can be carried out over any content object at any time. Moreover such dividing operations can be carried out over certain content objects at the same time that event capture module 108 is observing user interactions over certain other content objects. In fact, and as shown, the event capture module can be configured to observe user interaction events over any of the previously divided content objects.

In the use case shown in FIG. 1A1, observations of user activity of a first CMS user and/or inferred interests of the first CMS user over a pre-labeled content object serve to inform the fine-grained recommendation module. The fine-grained recommendation module in turn emits a fine-grained recommendation that refers to a particular portion of the content object (e.g., the portion corresponding to first user's interest) as well as the content object itself. Given the aforementioned fine-grained divisions of the document, and given that a first user expresses interest in one or more of the particular logical portions of a content object, that aspect can be exploited by the recommendation system. More specifically, the determination that some particular logical portion of some particular content object is interesting to a first user can be used to in turn make a recommendation to a second user.

To illustrate, consider that the first user and a subject second user are both workers in the revenue recognition department of a company. Now, further assume that both the first user and the second user need to review a certain particular portion of a subject shipment record (e.g., bill of lading). It would thus be of high utility for the second user to know of the observed interest (by the first user) over that certain particular portion of that particular shipment record. Such utility can be enhanced by certain automated actions taken by the CMS. For example, when the second user opens a subject document (e.g., the aforementioned subject shipment record) the system itself can automatically scroll or page to the certain particular portion of that particular shipment record.

The foregoing example scenario encompasses drawing one or more user interest inferences based at least in part on the first user's interactions over a particular portion of a content object. Moreover, the foregoing example scenario encompasses the notion that the interests of a first CMS user might match or map to the interests of a second CMS user. Implementation of the notion of “mapping” or “matching” can include (1) matching that both the first user and the second user edited a particular logical portion of a document, (2) matching that both the first user and the second user added a comment to a particular logical portion of a document, (3) matching that both the first user and the second user caused a version change when interacting over a particular logical portion of a document, etc.

Techniques for inferring user interests are discussed infra. Furthermore, techniques for determining second or Nth CMS users are discussed infra.

As used herein, a “content management system” is a collection of executable code that facilitates performance of a set of coordinated functions, tasks or activities on behalf of a plurality of collaborating users that operate over shared content objects. More specifically, a content management system facilitates collaboration activities such as creating a shared content object and establishing a set of users who can access the shared content object concurrently. In some embodiments as contemplated herein, a “content management system” is implemented as a set of computer-implemented modules that interoperate to capture, store, and provision access to electronically-stored data that comprises a history of events taken over shared content objects. Access by users to individual ones of the content objects of a content management system is controlled by collaboration group settings.

As used herein, a “content object” is any computer-readable, electronically-stored data that is made accessible to a plurality of users of a content management system. Different content management system users may each have respective permissions to access the electronically-stored data. The electronically-stored data may be structured as a file, or as a folder/directory, or as metadata.

In the embodiment of FIG. 1A1, the shown fine-grained recommendation module 104 is configured to interpret user events 116 (e.g., using a user interest interpreter module 106) so as to infer user interest on particular logical portions of a document based on the nature of the user events. For example, if the event capture module 108 captured that a user U₁ (e.g., or user U₂, or user U₃) had (for example) spent a lot of time interacting with the logical portion LP1 of document D1, and had spent no time or little time interacting with the logical portion LP2 or logical portion LP3 of document D1, then it might be inferred that user U₁ has an interest in logical portion LP1.

As can be seen, there may or may not be any semantics associated with any particular logical portion. Moreover there may or may not be any classification of the type of interest. Nevertheless, the configuration of FIG. 1A1 is still able to correlate a particular logical portion of a document to a particular user based on a history of the user's interactions over the document.

In some cases certain behaviors can be construed from the type and nature of user events. For example, the event capture module might detect that a user is dwelling over a certain portion of a document, or, the event capture module might detect that a user is making many edits and/or adding many comments to a certain portion of a document. As such, user interest can be gauged not only in a binary sense (e.g., interest expressed or no interest expressed), but also user interest can be gauged by an intensity value or time duration or level indication. In some embodiments, any one or more of an intensity value and/or a time duration and/or a level indication can be combined to result in an aggregated interest level. In some embodiments, any one or more of an intensity value and/or a time duration and/or a level indication can each be associated with respective weights that are used when calculating an aggregated interest level. For example, a quantitative gauge of an aggregated interest level might be calculated by a sum of products calculation where each of the aforementioned products is calculated by multiplying a specific interaction value by its corresponding weight. As such, a system can be configured such that an explicit, active interaction type (e.g., adding a comment to a document section) might be deemed to be more indicative of interest that an implied, passive interaction type (e.g., merely hovering a mouse over that same document section).

Further details regarding general approaches to gauging user interactions are described in U.S. application Ser. No. 17/816,329 titled “CONTENT MANAGEMENT SYSTEM INTEGRATIONS WITH WEB MEETINGS” filed on Jul. 29, 2022, which is hereby incorporated by reference in its entirety.

The scenario of FIG. 1A1 encompasses emitting a recommendation to a second CMS user based on interactions and/or interests of a first CMS user. In some cases, the decision to emit a recommendation pertaining to a particular logical section of a document based on interactions and/or interests of a first CMS user can be confirmed or strengthened by comparing the first CMS user's interaction to a second CMS user's interactions over the same particular logical section of a document. In addition to the utility of emitting a recommendation to a second user based on a first user's interactions, there are many situations where it is felicitous to emit a recommendation pertaining to a particular logical section of a second document based on interactions and/or interests of a first CMS user. Such a scenario is shown and discussed as pertains to FIG. 1A2.

FIG. 1A2 exemplifies a recommendation system that emits fine-grained recommendations to second or Nth documents based on a first user's interactions. More specifically, the shown flow corresponds to the scenario where (1) various content object corpora (e.g., corpus C1, corpus C2, . . . , corpus CN) are stored in a storage system repository 110; (2) any number of documents (e.g., document D1, document D2) are selected from the content object corpora (operation 4); (3) logical portions of the document (e.g., logical portion LP1, logical portion LP2, and logical portion LP3 of document D1) are identified and labeled (operation 5); (3) specific interactions by a first CMS user over portions of a first document are observed and processed; and (4) specific portions of other documents are recommended to the first CMS user (operation 6). This corresponds to semantics of, “If you liked the martial arts scenes from the movie, ‘Jackie Chan in the Kitchen,’ we think you will like the martial arts scenes from the movie ‘Jackie Chan Meets Godzilla.’”

In this embodiment, making fine-grained recommendations is facilitated by invoking a fine-grained recommendation module that distills user events over a first content object (e.g., document D1) into user interests, and then correlates the user's interests to specific logical portions of a different document (e.g., document D2).

The foregoing document D1 and document D2 can be any sort of content object, and the foregoing logical portions (e.g., logical portion LP1, logical portion LP2, and logical portion LP3 of document D1, and logical portion LP1′, logical portion LP2′, and logical portion LP3′ of document D2) can be any arbitrary portions of the respective content object.

The storage system repository can be any storage facility, such as network attached storage or storage area networks, or cloud-based storage, or data blobs in a database, etc. Moreover, any one or more of the foregoing corpora of the storage system repository can include movies or other streaming media, photos or other images, music or other audio files, virtual white board assets or other online meeting assets, lists or other structured data, metadata, etc. The following figures, FIG. 1B1, FIG. 1B2, FIG. 1B3, FIG. 1B4, FIG. 1B5, FIG. B6, and FIG. 1B7 give specific examples of how specific portions of specific content objects can be broken down into logical portions, which in turn can be correlated with user interactions over those logical portions.

FIG. 1B1 depicts an example fine-grained document labeling technique as used in systems that infer fine-grained recommendations based on user interactions with portions of a document. As an option, one or more variations of fine-grained document labeling technique 1B100 or any aspect thereof may be implemented in the context of the architecture and functionality of the embodiments described herein and/or in any environment.

This technique involves labeling based on an offset (e.g., from the beginning of a document) to the particular logical portion. For example, the table of contents (TOC) of a particular document might be labeled as beginning at “offset 129” which refers to the 129^{th} byte after the beginning of the document. Alternatively, a logical portion might be described by a range (e.g., range R1, range R2, . . . , range RN) that has a start address and either an end address or a count (e.g., a count of bytes or characters). Two or more ranges might be identified by two or more address ranges that correspond to two or more logical portions of a particular single file, wherein the two or more address ranges define locations within the particular single file;

Any number of logical portions of a document can be identified using any known technique. In an example where the document is a file that contains computer code (e.g., in a script language, or in a high-order language, or in a mnemonic language, etc.) various logical portions of the document can be identified and ranged based on the syntax or semantics of the computer code.

FIG. 1B2 depicts an example streaming media scene breakdown as used in systems that infer fine-grained recommendations based on user interactions with streaming media. As an option, one or more variations of streaming media scene breakdown 1B200 or any aspect thereof may be implemented in the context of the architecture and functionality of the embodiments described herein and/or in any environment.

This technique involves a break down of a movie or other streaming media 114 into parts P1, P2, . . . , PN. The parts might correspond to scenes (e.g., scene scene1, scene scene2, etc.), which in turn might be codified by a timecode offset (e.g., timecode1, timecode2, . . . , timecodeN). In some cases, a scene may be presented as a reprise, such as is depicted by part PN, which is a second instance of scene scene2.

FIG. 1B3 depicts an example feature-level breakdown as used in systems that infer fine-grained recommendations based on user interactions with an image. As an option, one or more variations of feature-level breakdown 1B300 or any aspect thereof may be implemented in the context of the architecture and functionality of the embodiments described herein and/or in any environment.

This technique involves identification of features of an image 115. As shown, a single image might contain several identifiable features (e.g., feature feature1, feature feature2, feature feature3).

Although the foregoing refers specifically to an image and features therein, for generality a subject content object can be any type of object, and moreover, identification of features and/or extraction can be facilitated by known-in-the-art techniques such as optical character recognition, video and/or audio pattern matching, ambient sound pattern extraction, etc. In some cases, an aspect or aspects of any results from identification of features and/or extraction of features can be employed to bound ranges that are in turn used in codifying fine-grained recommendations. In some cases, the identification of features and/or extractions that can be used to generate a topic-based recommendation can be facilitated by topic-based analysis of a given portion of a content object. In some cases, a particular feature or extraction can be labeled with a topic-specific tag. For example, a passage that includes the phrase, “Now is the time for all good men to come to the aid of their party.” might be subjected to topic-based analysis which in turn might return topic codes such as {tagSuffix=“PATRICKHENRY”, tagSuffix=“POLITIC S”, tagSuffix=“TYPEWRITER”, etc.}.

FIG. 1B4 depicts an example range breakdown as used in systems that infer fine-grained recommendations based on user interactions with an audio file. As an option, one or more variations of range breakdown 1B400 or any aspect thereof may be implemented in the context of the architecture and functionality of the embodiments described herein and/or in any environment.

This technique involves breakdown of an audio clip 116 into ranges (e.g., range range1, range range2, . . . , range rangeN). A range can be defined by an arbitrary length or duration, or a range can be defined based on actual audio content (e.g., a portion containing speech, a portion containing music, a portion containing silence, etc.).

FIG. 1B5 depicts an example virtual whiteboard asset breakdown as used in systems that infer fine-grained recommendations based on user interactions in an online meeting. As an option, one or more variations of virtual whiteboard asset breakdown 1B500 or any aspect thereof may be implemented in the context of the architecture and functionality of the embodiments described herein and/or in any environment.

This technique involves extracting assets from a virtual whiteboard 152 or from some other portion of an online meeting canvas 150. As shown, an asset might be a sketch (e.g., extraction extraction1) or an asset might be an avatar (e.g., extraction extraction2), or an asset might comprise a range of text (e.g., extraction extraction3), and so on.

Further details regarding general approaches to extracting assets from a whiteboard and/or for extracting features from images are described in U.S. Pat. No. 10,867,209, issued on Dec. 15, 2020, which is hereby incorporated by reference in its entirety.

FIG. 1B6 depicts an example list element breakdown as used in systems that infer fine-grained recommendations based on user interactions with structured data. As an option, one or more variations of list element breakdown 1B600 or any aspect thereof may be implemented in the context of the architecture and functionality of the embodiments described herein and/or in any environment.

This technique involves labeling components of structured data in a manner that supports determination of a user's interest in a particular labeled component. In some cases the structured data is codified using a computer readable language such as the extensible markup language (XML), Java script object notation (JSON), Apache Avro, etc. In some such cases, the label can correspond to a syntactical element of the structured data, such as an element in a set of comma separated values, or a label can correspond to a key or value in a key-value pair.

The example shown depicts data that is structured as a list. In this example, the list comprises a sequence of list constituents (e.g., formatted data1, formatted data2, . . . , formatted data99), each of which individual ones of the list constituents can be labeled individually.

FIG. 1B7 depicts an example metaverse 1B700. The shown embodiment includes graphical representations of a document in a digital reality. As used herein, a metaverse is a digital reality that combines aspects of social media, online gaming, augmented reality (AR), virtual reality (VR), and/or cryptocurrencies to allow users to interact virtually. In example cases, a digital reality overlays visual elements (e.g., images, features of images, representations of documents and/or displayed contents of documents, etc.), sound, and other sensory input onto real-world settings to enhance the user experience. As shown, a visual element of a metaverse might be or correspond to a document that is accessible via a hypertext transport protocol link.

Constituents of a metaverse can be expressed at any one or more levels of granularity. It sometimes happens that a metaverse may be organized hierarchically such that one level of a particular hierarchy serves as a beginning location for a lower level of a hierarchy and so on. For purposes of making fine-grained recommendations, any one or more levels of the hierarchy can be considered. The utility of a recommendation and, more particularly, an optimal degree of utility of a recommendation may be a function of either a location (e.g., a location in the metaverse hierarchy) or a function of a particular user (e.g., based on the particular user's profile) or both.

FIG. 1C1 presents a utility chart as used to define an optimal granularity level of fine-grained recommendations. As an option, one or more variations of utility chart 1C100 or any aspect thereof may influence the configuration of the embodiments described herein and/or in any environment.

The chart shows a “sweet spot” (near the middle of the chart) where the granularity is at an optimal level for human cognition. This sweet spot is distinguished from the granularity of legacy recommendation systems, and is further distinguished from being too coarse a granularity or too fine a granularity.

In the context of some of the herein-disclosed embodiments, the sweet spot corresponds to chapters of a book, scenes of a movie, features of a photograph, elements of a list, etc. Any type of document can be labeled by using extra-document labeling techniques such as via metadata, or by using intra-document marking techniques, or by using a combination of the foregoing techniques. With respect to metadata, metadata in a CMS may come from manual input, or from templates and/or from patterns that emerge, or from any other known technique.

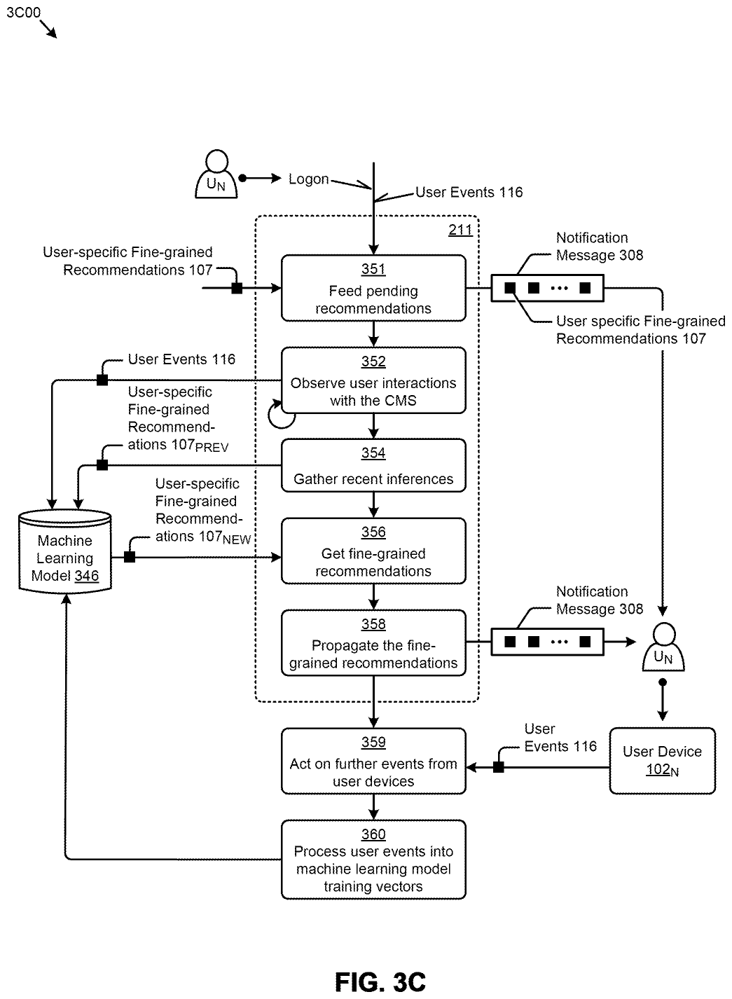

The boundaries of a sweet spot (e.g., the aforementioned chapters of a book, scenes of a movie, features of a photograph, elements of a list, etc.) can be automatically determined based on existing labels and or based on labeling rules that are applied to content objects. Moreover user interest over any one or more of the bounded portions of a particular content object can be gauged in real time. One possible operation flow for generating fine-grained recommendations based on user interactions within a content management system is shown and described as pertains to FIG. 2.

FIG. 1C2 presents a data structure to represent a user-specific fine-grained recommendation. As shown, the user-specific fine-grained recommendation data structure 189 is configured to associate a user (e.g., via the shown logical identifier of a CMS user), a document (e.g., via the logical identifier of a content object), and corresponding one or more fine-grained recommendations (e.g., as depicted by the several occurrences of a field of the data structure that contains logical identifiers to a location in the content object).

FIG. 2 presents an operation flow as used in systems that infer fine-grained recommendations based on user interactions within a content management system. As an option, one or more variations of operation flow 200 or any aspect thereof may be implemented in the context of the architecture and functionality of the embodiments described herein and/or in any environment.

The figure is being presented to illustrate operations of a system that responds to user events by (1) inferring user interest over particular portions (e.g., chapters, scenes, list items, etc.) of the subject content object, and (2) by formulating fine-grained recommendations that correlate certain of the particular portions to a quantitative user-specific interest level. The fine-grained recommendations are codified in a manner that facilitates application to content objects other than the subject content object. For example, if a user showed particular interest in a particular scene of a Jackie Chan movie where a martial arts contest was waged in the kitchen of a restaurant, then the kitchen scenes of other martial arts movies might be recommended to that user.

The shown embodiment commences when a user raises some event (e.g., an “open” event) over a particular subject content object. This event invokes process 210 to label the subject content object. Location labeling rules 202 may be accessed during execution of process 210. Process 210 serves to label locations of the particular subject content object in accordance with location labeling rules and/or content object attributes. Location labeling rules may include generic rules that can be applied to many different types of content objects and/or may be applied to many different types of content object attributes 131. Additionally or alternatively, such location labeling rules may include object-specific rules that are configured to be applied to specific types of content objects. For example, a content object that is a MICROSOFT WORD™ document might be labeled based on particular styles used in the MICROSOFT WORD document.

Once labels for particular content objects have been generated, updated versions (e.g., labeled versions) of the subject content objects can be stored as labeled content objects 204. In some embodiments, labeling is done as soon as a new content object is saved into the storage system repository. In other embodiments, labeling of a particular content object is deferred until there is at least some indication that a user will act on the particular content object.

As shown, user interactions (e.g., actions raised by user U_{N}) are ingested by process 212, which operation serves to infer the user's interest on particular locations of the particular subject content object based on observed interactions. Such inferences can be based in whole or in part on whether or not an inferencing rule fires. Strictly as an illustrative example, a rule may be codified as “IF (interaction.firstInteraction==pageTo) THEN set interestTag.location=interaction.pagedTo.location”, which carries the semantic of “associate user interest to the location of the document that the user first pages to (e.g., after opening the document). As another illustrative example, a rule might be codified as “IF (document.location.hovertime>hoverThreshold) THEN set interestTag.location=document.location”, which carries the semantic of “associate user interest to the location of the document that the user had been hovering over” (e.g., after opening the document).

Process 212 can be configured to continuously observe interactions by a particular user. In some cases process 212 emits multiple inferred interests 219 in a given iteration. In other cases, process 212 emits a single inferred interest in a given iteration. In some cases, process 212 continues to observe interactions over time, yet without emitting inferences. This can happen when there are few or no observable interactions. It can also happen when no interaction rules fire.

At some moment in time, possibly after the occurrence of a user action taken over the subject content object, or possibly when the subject content object is closed, a FORK-JOIN block (e.g., block 211) is entered. Processing within the FORK-JOIN block incudes (1) determining how to act on the subject content object in the future (e.g., step 213), as well as (2) formulating fine-grained recommendations for the user to access specific portions of other content objects (step 214). The FORK-JOIN block can be entered any number of times. In some cases, the FORK-JOIN block is entered upon completion of a user interaction. In other cases, and as shown, the FORK-JOIN block is re-entered by operation of loop 216, which loops back into process 212.

In the shown embodiment of step 213, processing of inferred interests 219 codifies a notification of a change (or addition) of an interest 207. In the shown embodiment of step 214, one or more user-specific fine-grained recommendations 107 are codified. Any combination of the inferred interests and/or the codified notifications and/or the specific fine-grained recommendations can be used by step 217 to deliver recommendations to a particular user.

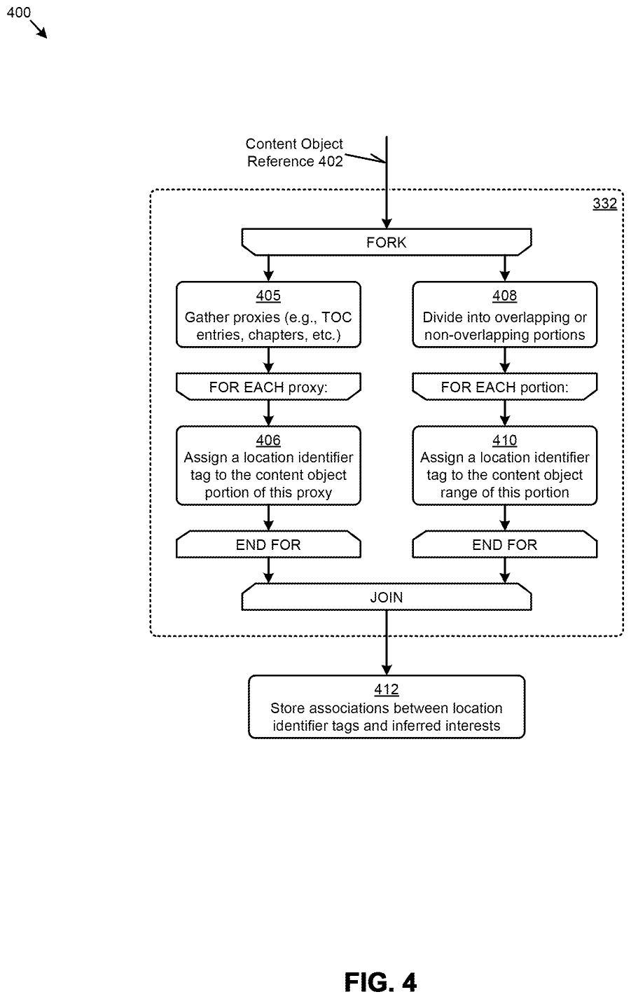

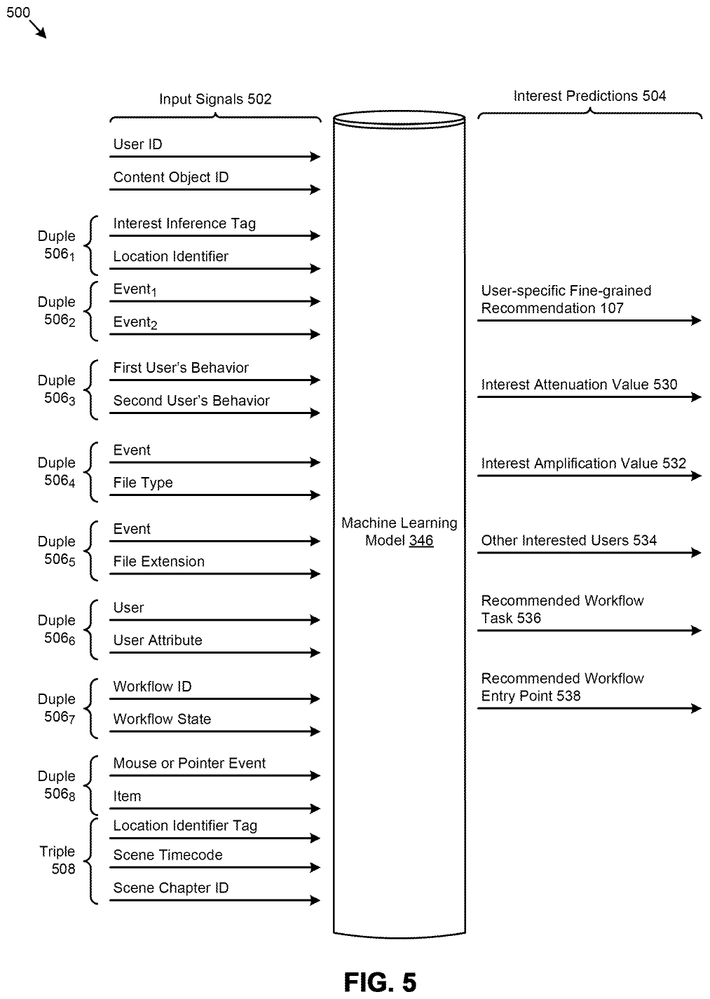

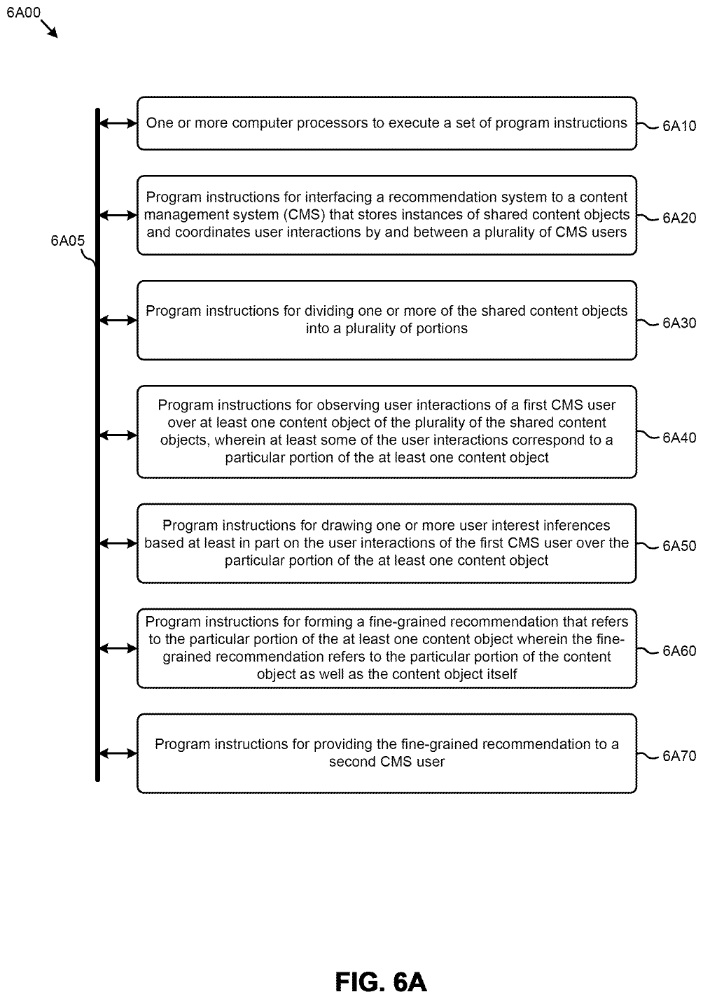

Operation flow 200 can be implemented by any combination of hardware and software. In exemplary cases, operation flow 200 is implemented within a content management system. Such an embodiment where operation flow 200 is implemented within a content management system is shown and described as pertains to FIG. 3A.

FIG. 3A presents a content management system that emits fine-grained recommendations based on user interactions with content objects. As an option, one or more variations of content management system 3A00 or any aspect thereof may be implemented in the context of the architecture and functionality of the embodiments described herein and/or in any environment.

The figure is being presented to provide one possible hardware and software configuration that is capable of forming and propagating the herein-disclosed fine-grained recommendations. Moreover, the figure is being presented to illustrate how different users, each with different interests, can each receive different recommendations.

The figure illustrates a cycle whereby users (e.g., user U₁, user U₂, . . . , user U_{N}) raise user events 116 over content objects, which user events are used to infer or predict each user's interests. Such user-specific interests are in turn used to feed user-specific fine-grained recommendations (e.g., user-specific fine-grained recommendation 1071, user-specific fine-grained recommendation 1072, user-specific fine-grained recommendation 107N) to corresponding particular users. User-specific fine-grained recommendations are delivered to corresponding users through a user interface (e.g., user interface 3041, user interface 3042, . . . , user interface 304N) of a particular user's user device (e.g., user device 1021, user device 1022, . . . , user device 102N). When a user acts on a recommendation, the cycle repeats.

The user-specific fine-grained recommendations are recommendations for a particular user to access a particular location in a particular content object. The particular content object can be accessed from any corpora of shared content objects of the CMS. In the example shown, the corpora of shared content objects includes content objects 306_{MEDIA}, content objects 306_{CONTRACTS}, content objects 306_{OTHER}, etc.). Different users express different interests in different content objects, based at least in part on user-specific attributes 325. Moreover, different users express different interests in different portions of different content objects, based at least in part on user-specific attributes 325. Strictly as an example, a first user might particularly be interested in the “Indemnification and Warranty” section of contracts, whereas a second user might be particularly interested in the “FORCE MAJEUR” section of contracts.

In some situations, the various user-specific attributes can be used to identify second and Nth users who are in some way deemed to have similar interests. For example, if a first user is interested in the “FORCE MAJEUR” section of contracts, then it can be deemed that a second or Nth user who is in the same collaboration group of the CMS might also have the same or similar interest. Accordingly, the identified second or Nth users can be notified. Furthermore, if a particular automated operation 335 had been determined based on interests of a first user, then other users— specifically users like the first user—can also receive the benefit of the particular automated operation. Any number or variety of relationships and/or associations between a first CMS user and second and Nth CMS users can be used to determine which second or Nth CMS users are in some way like the first user. Moreover any number or variety of relationships and/or associations between a first CMS user and second and Nth CMS users can be used to determine automated operations.

Continuing the example, if it were deemed that the system should automatically scroll to the “FORCE MAJEUR” section of a subject contract (e.g., at the time the subject contract is opened), then that same automatic scrolling action to the “FORCE MAJEUR” section of the same subject contract can be performed on behalf of the second or Nth user. The foregoing is merely an example. There are many other examples that are within the scope of performing an automated operation based on user-specific fine-grained recommendations.

As used herein, user-specific fine-grained recommendations refer to a suggestion to a particular user to access a particular portion of a content object wherein the fine-grained recommendation specifies the portion of the content object (and not merely the content object itself).

Recommendations can be delivered to users via notification messages 308. As shown, notification messages 308 may include user-specific fine-grained recommendations (user-specific fine-grained recommendations 1071, user-specific fine-grained recommendations 1072, user-specific fine-grained recommendations 107N) that are presented (e.g., using user interface 3041, using user interface 3042, using user interface 304N) to respective specific users (e.g., user U₁, user U₂, user U_{N}).

The content management system 3A00 can be configured to feed notification messages to users using any known technique. Strictly as examples, a notification can be delivered to a user via any one or more of, an email 307, a short message service (SMS 309) message or ‘text’, a push 311 notification to a user device, a SLACK™ message, or a MICROSOFT™ TEAMS message, etc. User profiles accessible by the CMS can be used to store user preferences as pertains to a user's preferred method of delivery. In some implementations, user preferences as pertains to a user's preferred method of delivery may further include rules for filtering and/or batching, and/or such rules may codify constraints such as pertaining to time of day for delivery of notifications.

In some cases content management system 3A00 can be configured to deliver notification messages to a third-party application, which in turn feeds user-specific fine-grained recommendations to the intended user. Such a third-party application can merely relay the user-specific fine-grained recommendations to the intended user, or the third-party application can enrich the notification and/or the user-specific fine-grained recommendations based on information available to the third-party application. In some cases the third-party application has direct access to information (e.g., information about particular users) that is not directly available to the CMS. As such, a third-party application can influence the nature and timing of feeding recommendations to particular users.

Further details regarding general approaches to feeding recommendations to particular users are described in U.S. Pat. No. 11,405,468 titled “FORMING ACTIVITY STREAMS ACROSS HETEROGENEOUS APPLICATIONS” issued on Aug. 2, 2022, which is hereby incorporated by reference in its entirety.

The content management system 3A00 is configured as a collaboration server 310, which collaboration server implements fine-grained recommendation module 104. The fine-grained recommendation module in turn is composed of an event collection processor 312, a machine learning system 314, and a recommendation message generator 316.

The foregoing event collection processor, machine learning system, and the recommendation message generator operate cooperatively. After the event collection processor gathers and processes user events, it (1) stores (e.g., into event record history 322) some of the gathered events, and (2) passes codified user events to the machine learning system 314. The gathered and processed events may correspond to observed user device interactions which in turn may correspond to any one or more then-current user events 116 that originate from then-current interactions that are raised at corresponding user devices. Additionally or alternatively, the gathered and processed user events may be events that are taken from a history of events. User events can include any/all of, upload events, download events, open events, object creation events, object modification events, object renaming, etc.

In some cases the event collection processor can combine two or more events that are taken from a history of events to form a compound event. Such compound events can be used by the machine learning system to infer or learn user interests. For example, if a user opens a document, say “Contract Z” and then, before closing the document, the user navigates to the “FORCE MAJEUR” section of a contract, that combination of events can be deemed to indicate that the user is interested in “FORCE MAJEUR” provisions of a contract.

Continuing the discussion of how the event collection processor, the machine learning system, and the recommendation message generator operate cooperatively, FIG. 3A shows that particular user events (e.g., selected user events 318) are selected as inputs to a machine learning model. The machine learning model in turn outputs one or more predicted user-specific interests 320. The determination of such predicted user-specific interests can be made based on a trained learning model. Such training can be based on a history of events (e.g., as drawn from event record history 322). Just as one example, if the history of events showed that a particular user typically scrolled to a particular logical portion 331 of the contract (e.g., to the “FORCE MAJEUR” provisions of the contract), then the model can be trained with input signals pertaining to events of that user opening a contract document and an output referring to the act of scrolling to a particular logical portion of the contract (e.g., the “FORCE MAJEUR” provisions).

A proposed set of events (e.g., an event corresponding to when a user opens a contract document) would drive a prediction that the user is typically interested in the “FORCE MAJEUR” provisions of any contract. As such, given a larger set of training vectors (e.g., inputs and corresponding predictions) possibly involving many user profiles 324 and over a long time period and involving many user-specific attributes 325, a learning model with high precision and recall can be trained to learn user interests pertaining to particular portions of a content object.

Now, given outputs from the machine learning system (e.g., outputs of a specified confidence value), a recommendation message generator can be invoked. The recommendation message generator can emit recommendation messages that are directed to users (e.g., as depicted by notification message 308) and/or the recommendation message generator can emit recommendation messages that are directed back into the collaboration server. Strictly as examples, the recommendation message generator can emit a recommendation of an action that raises workflow even 317. Additionally or alternatively, the recommendation message generator can emit a recommendation of an action that invokes application programming interface call 319.

The particular content management system 3A00 is configured as a collaboration server 310, which collaboration server implements fine-grained recommendation module 104. However, in addition to the shown fine-grained recommendation module 104 of FIG. 3A, there are many alternative configurations of processing flows within a content management system. One possible processing flow is shown and described as pertains to FIG. 3B.

FIG. 3B presents an example rule-based processing flow as used in systems that infer fine-grained recommendations based on user interactions within a content management system. As an option, one or more variations of rule-based processing flow 3B00 or any aspect thereof may be implemented in the context of the architecture and functionality of the embodiments described herein and/or in any environment.

The figure is being presented to illustrate how a content management system can be configured (step 326) to carry out labeling of content objects and training of a machine learning model in parallel. More particularly, it should be noted that a content management system might host thousands or millions (or more) content objects. In some situations it might be appropriate to label a content object upon the event of creation of that content object. On the other hand, there might be thousands or millions (or more) content objects that have not yet been labeled. To accommodate this, some content management systems run one or more background tasks that iterate through the thousands or millions (or more) content objects, so as to label each one in the expectation that a user will eventually interact with the labeled content. The herein-disclosed techniques for labeling content objects can operate in parallel with herein-disclosed techniques for training a machine learning model. This is shown by the FORK-JOIN block of FIG. 3B. Specifically the figure shows that one or more instances of process 210 executes in parallel with one or more instances of process 212.

The step-by-step depiction of process 210 (e.g., step 328 through step 334) is merely one illustrative example of how to label content objects. Other techniques for labeling content objects are possible. In the shown illustrative labeling example of FIG. 3B, a content object is accessed (step 328) and, based on the nature (e.g., file type, content type, etc.) of the content object, one or more location labeling rules 202 are selected for evaluation (step 330). In the event that one or more of the location labeling rules fires, then the location or locations where the labeling rule fired is associated with an applicable label tag (process 332). For example, if the content object is a movie, and the movie is organized as a series of chapters or scenes, then one or more locations in the movie (e.g., the beginning of a chapter, the beginning of a scene, etc.) are tagged as determined by the labeling rules. In some cases, the one or more locations as determined by the labeling rules are tagged with one or more label tags 333 (e.g., metadata) that carries the meaning that that location is at a boundary of a chapter or scene. In other cases, the one or more locations as determined by the labeling rules are tagged with a label tag (e.g., metadata) that refers to a number or other unique identifier. The resulting content object is stored in a labeled content objects 204₀.

Concurrent with execution of process 210, process 212 serves to make inferences and use some of those inferences to train a machine learning model. The shown labeled content objects 2041 can be the same labeled content objects 204₀ as output by process 210. Alternatively, the shown labeled content objects 2041 can be an earlier version of labeled content objects 204₀ as output by process 210. The shown labeled content objects 2041 can be accessed by any step of process 212. In the example shown, step 338 is configured to observe user interaction events that occur on or over any one or more of the labeled content objects. Such observations can be carried out continuously. In some embodiments all of step 338, step 340, step 342, and step 344 are carried out continuously and asynchronously. In some cases all of step 338, step 340, step 342, and step 344 are invoked as frequently as there are incoming instances of user events 116.

Given an observation of a user interaction over a portion of a labeled content object, step 340 serves to associate an interest tag (e.g., a location, passage, chapter, etc.) with a subject event. Step 340 can be informed by any number of association types (i.e., rules) rules. Further, a particular subject event may in turn be associated to a particular offset (e.g., byte offset) in a particular content object. As such, when there are particular types of user interactions over a portion of a labeled content object, the fact and nature of that user interaction can be used to draw interest inferences.

Strictly as an example, if a user made one or more edits to some portion of a labeled content object, then it can be inferred that that user is especially interested in that passage. On the other hand, if the user a did not make any edits to other portions of that same labeled content object, then it can be inferred that that user is not especially interested in that passage.

TABLE 1

| Association | Interest Inference | |
|---|---|---|
| Type | Codification (per user) | System Action |
| User event at | Inference0{EVENT_TYPE, | Open at location |
| location | <fine-grained location>} | |
| Scroll to | Inference1{SCROLL_STOP, | Scroll to location |
| location | <document location>} | upon open |
| Hover over | Inference2{HOVER_REGION, | Zoom in to location |
| image feature | <feature box>} | |
| Rewind to | Inference3{REWIND, | Forward to chapter |
| time range | <chapter or time range>} | |
| Pause at | Inference {PAUSE, | Forward to chapter |
| time range | <chapter or time range>} | |

Interest inferences can be codified with respect to a quality of the interest inference, or with respect to a quantity of the interest inference, or with respect to an intensity of the interest inference. Moreover, any of the qualities, quantities, and/or intensities can be quantized and/or normalized into ranges (e.g., HIGH, MEDIUM, LOW), and such qualities, quantities, and/or intensities codified into ranges can be used as signal inputs into a machine learning model.

Making associations between user interactions and particular locations can be informed by association rules 348. More particularly, such association rules can be configured to relate a wide range of user interaction events to specific interest tags 349. Strictly as one example, if a user interaction event or series of user interaction events occur over an long amount of time, then an interest tag that carries the meaning of “high interest” might be associated with the user interaction event or events. If on the other hand there are only scrolling events that occur over a range of content of the particular content object, then an interest tag that carries the meaning of “low interest” might be associated with the user's scrolling. Furthermore, if the range of content of the particular content object had been labeled, then the user's scrolling interactions might be associated with the locations in the subject document that correspond to the labeled portions that in turn correspond to dynamic aspects of the user's scrolling interactions.

Making fine-grained inferences can be time saving for certain users. Consider a scenario where a first user routinely pages through a contract document to get to the place where the “INDEMNIFICATION” provisions are found. Further consider that a second user routinely pages through a contract document to get to the place where the “FORCE MAJEURE” provisions are found. In this scenario, it would be time saving if the CMS were to automatically scroll or page to the section (e.g., either the “INDEMNIFICATION” section or the “FORCE MAJEURE” section) that is of interest to the corresponding user. In certain embodiments, second or Nth users are selected on the basis of some commonality between the first user and the second or Nth users. In certain embodiments, second or Nth users are selected on the basis of shared interests (including but not limited to inferred interests) between the first user and the second or Nth users. In certain embodiments, second or Nth users are selected on the basis of some commonality or association of user interactions that had been observed by both the first user and the second or Nth users.

Now, given that there can be as many associations (or more) as there are user interactions, those association can be used in combination to draw interest inferences. Inference rules 350 can inform step 342 as to if, or how any particular combination of associations can be used when making interest inferences 343. Strictly as one example, consider a content object that is a movie, and further consider the existence of (1) an association between a first fast rewind command occurrence and a particular portion of labeled content, (2) an association between a second fast rewind command occurrence over the same portion of the labeled content, (3) an association between playback speed (e.g., where fast forward indicates low user interest), (4) an association between volume level and/or volume mute (e.g., where a low volume indicates low user interest) and (5) an association between a pause command occurrence over the same portion of the labeled content. From this interaction, it can be inferred that that portion of the labeled content is of high interest to the user. Any one or more of such inferences can be saved in stored inferences 395 and/or otherwise delivered to downstream processing.

In some embodiments, user-specific fine-grained recommendations 107 are delivered to the corresponding user or users immediately upon formulation of the recommendation. In other embodiments, delivery of any one or more of the user-specific fine-grained recommendations is deferred until a later time. One possible implementation where delivery of the user-specific fine-grained recommendations is deferred until a later time is shown and described as pertains to FIG. 3C.

FIG. 3C presents an example recommendation delivery system. As an option, one or more variations of recommendation delivery system 3C00 or any aspect thereof may be implemented in the context of the architecture and functionality of the embodiments described herein and/or in any environment.

The figure is being presented to illustrate mechanisms by which notifications (e.g., feeds) are delivered to users when they are actually logged in to the CMS. This specific embodiment is one possible implementation of FORK-JOIN block 211 of FIG. 2. Invocation of the shown recommendation delivery system is commenced by a logon event. Once logged in, the user may raise myriad further user events. For example, user U_{N} might interact with a user interface to access resources of the CMS.

At some point during the login session, the recommendation delivery system can open a socket or other mechanism to be able to send notification messages 308 to the logged-in user (step 351). In some cases, there may be any number of previously determined recommendations that are then currently pending and/or have been pending for presentation to a particular user. As such, step 351 can process such previously determined user-specific fine-grained recommendations 107 by encapsulating or otherwise associating such previously determined user-specific fine-grained recommendations 107 into a notification message that is propagated to a user via that user's user device.

A series of notification messages may appear as a feed into a display area of the user's user device, and the user may operate the user's user device 102N and/or its corresponding user interface to act on one or more of the notifications or recommendations (step 359). In some embodiments, whether or not a user acts on one or more of the notifications or recommendations is captured and used to train a machine learning model. In some embodiments analytics are performed over aspects of how a user acts on one or more of the notifications or recommendations, and the results of such analytics are used to train a machine learning model.

Additionally or alternatively, the recommendation delivery system might observe the logged-in user's interactions with the CMS (step 352). Observations may continue asynchronously until such a time that processing of the recommendation delivery system proceeds to collect recent (e.g., unprocessed) inferences (step 354). The observations (e.g., user events 116) and the collected inferences (e.g., the shown fine-grained recommendations 107_{PREV}) are provided (e.g., at step 356) as inputs to the machine learning model 346. The machine learning model in turn produces one or more newly determined outputs (e.g., the shown fine-grained recommendations 107_{NEW}), which are propagated (step 358) by encapsulating (or otherwise associating) any number of fine-grained recommendations into notification messages 308.

The user may act on the fine-grained recommendations, possibly by opening a document or movie, and then navigating to a recommended location (e.g., to a kitchen scene in a Jackie Chan movie). Additionally or alternatively, the CMS itself may act on the fine-grained recommendations, possibly by opening a document and automatically advancing to a recommended location. In some cases, a user may act on any of the fine-grained recommendations that might be provided in one or more notification messages emitted by operation of step 351 and/or as emitted by operation of step 358. Any of such user actions taken (or not taken) in response to the notification messages can be used as inputs to the learning model. Step 360 facilitates capture of learnings from user actions taken (or not taken) in response to the notification messages. Further, step 360 can be configured to format learnings from user actions taken (or not taken) into a format that is suitable as inputs to the learning model. More specifically, certain user actions taken in response to the notification messages can be provided to machine learning model 346 in a form that adjusts the machine learning model to increase or amplify inferred interests of that user. On the other hand, certain user actions that were suggested in previous recommendations that were not taken by the user can be provided to machine learning model 346 in a form that adjusts the machine learning model to decrease or attenuate the inferred interests of that user.

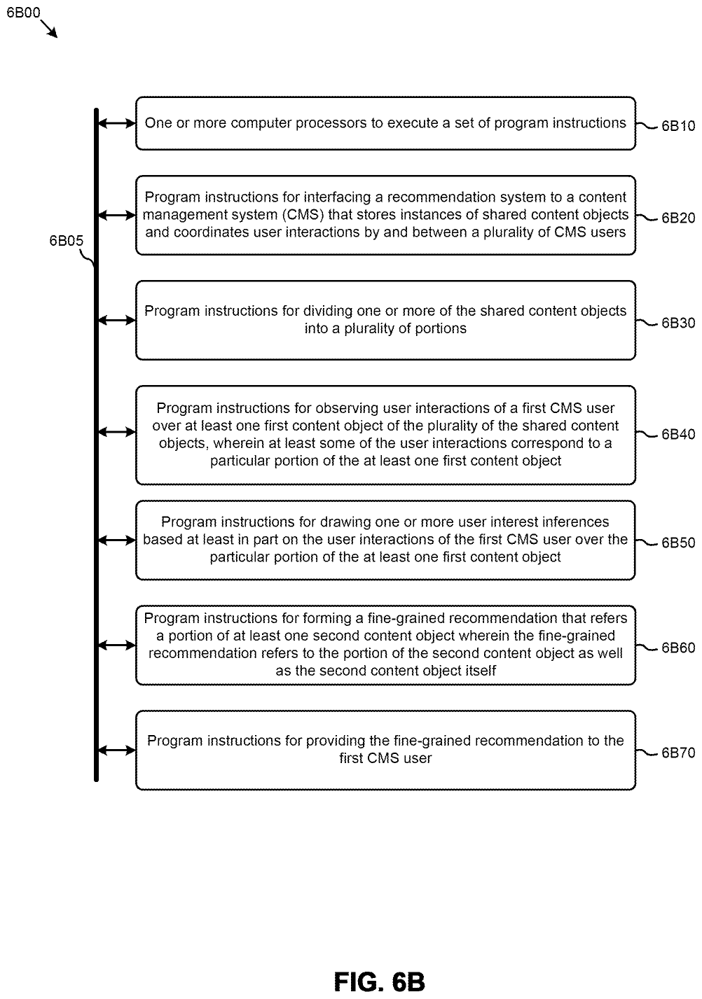

At least inasmuch as the foregoing recommendations are specific to a portion (e.g., a particular location or range) within a particular content object, techniques for labeling said portions needs to be provided. Example location labeling techniques are shown and described as pertains to FIG. 4.

FIG. 4 presents a location labeling technique 400 as used in systems that infer fine-grained recommendations based on user interactions with content objects. As an option, one or more variations of labeling technique 400 or any aspect thereof may be implemented in the context of the architecture and functionality of the embodiments described herein and/or in any environment.

The figure is being presented to illustrate ways to label locations within a content object. The label tags in turn serve to characterize various portions of a content object. In example implementations, a label tag, when applied to a portion of a content object, carries the semantics that that portion of the content object has or inherits various attributes. The label itself (e.g., as applied or otherwise associated with a portion of a content object) and/or any inherency drawn from the label can be used as features or signals to input into a machine learning model. Strictly as one example, if a particular user shows an interest in a particular movie scene where “Jackie Chan is in the kitchen,” then it might be inferred that that particular user would also be interested in a different movie scene where “Jackie Chan is in the kitchen.” Processes for codifying a recommendation to suggest that the user consider watching the different movie scene can be informed by knowledge (e.g., via content object location tagging) of the boundaries of scenes of a movie. As such, the labeling within FORK-JOIN block within process 332 is carried out any time a new content object reference 402 is provided. The shown FORK-JOIN block has two flows that can operate in parallel or in a sequence and/or asynchronously with each other.

The left flow relies on proxies for locations in a content object. More specifically, proxies for dividing up a particular content object into logical portions can be gathered (step 405) using any known technique. Strictly as one example, individual entries of a table of contents (TOC) can be analyzed to identify the beginning of a chapter. Similarly, again strictly as another example, individual entries of a DVD asset list can be analyzed to identify the beginning of a scene. Once a set of proxies has been gathered, the specific portions (e.g., ranges of bytes) or divisions (e.g., chapters or scenes) that correspond to the subject content object can be individually labeled with a location identifier tag (step 406). The location identifier tag might carry the same semantics as the proxy (e.g., chapter location, scene timecode, etc.) such that downstream processing can know the metes and bounds of the portions of a content object over which a user expresses interest. Further, downstream processing can use the metes and bounds of the portions of a content object when forming a recommendation.

The right flow can be used on any content object, even when no proxies for locations in a content object can be gathered (e.g., if there is no TOC, or if a content object does not contain markers that can serve as divisions). In this flow, step 408 divides the subject content object into individually identifiable portions. In one setting, step 408 divides the subject content object into individually identifiable portions by merely dividing the content object into M non-overlapping portions (e.g., M non-overlapping byte ranges). In some cases, the division might be informed by analysis of the contents of the content object. For example, an image might be divided into several portions that are defined as X pixel by Y pixel regions (e.g., rectangles).

At step 410, each of the foregoing portions or regions is assigned a location identifier tag (e.g., CHAPTER1_BEGINNING, SCENE2_BEGINNING, etc.), which assigned location identifier tags carries the semantics of a location of division or portion as well as a type of division or portion. Associations between location identifier tags and inferred interests can be stored (step 412) for downstream processing. Such associations can be one-to-many or many-to-many, or one-to-one. Strictly as examples, a single location might be associated with multiple inferred interests and/or with multiple topics.

As heretofore mentioned, downstream processing can use the metes and bounds of the portions of a content object when forming a recommendation. In some implementations, downstream processing can use location identifier tags as inputs to a machine learning model, which machine learning model can in turn be used when forming a recommendation.

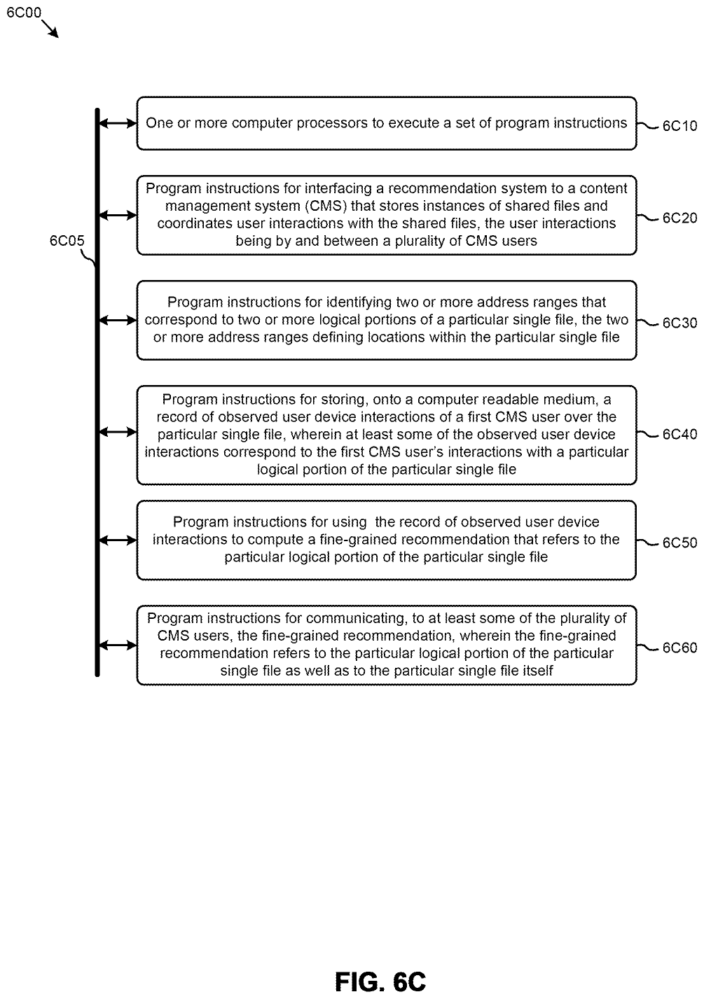

FIG. 5 presents a machine learning model as used in systems that infer fine-grained recommendations based on user interactions with content objects. As an option, one or more variations of the shown machine learning model configuration 500 or any aspect thereof may be implemented in the context of the architecture and functionality of the embodiments described herein and/or in any environment.

The figure is being presented to provide one possible set of input signals and outcomes (e.g., interest predictions 504) of a machine learning model. As is understood to those of skill in the art, a machine learning model might have hundreds or thousands or millions of input signals. At the outset, it might not be known by the learning model developers what signals are dominant in predicting a particular outcome; however, as time goes on and more and more training vectors (e.g., vectors with input signal values and corresponding outcomes) are ingested into the machine learning model 346, the dominance of any signal or set of signals might emerge.

In the example of FIG. 5, the input signals 502 include individual signals (e.g., user ID, content object ID) as well as many paired signals that are provided in a duple association (e.g., duple 506₁, duple 506₂, duple 506₃, duple 506₄, duple 506₅, duple 506₆, duple 506₇, duple 506₈) and triples (e.g., triple 508). The presented duples (e.g., interest inference tags with respect to a location identifier, event pairs such as event₁ and event₂, a first user's behavior with respect to a second user's behavior, an event with respect to a file type, an event with respect to a file extension, a user with respect to a corresponding user attribute, a workflow of interest with respect to that workflow's state, a mouse or pointer event with respect to the item or location, etc.) are presented here, not as an exhaustive list, but merely to exemplify the sort of signals that are available in a CMS. Additionally, and as shown, the input signals include, for example, a triple having a location identifier tag, a scene timecode, and a scene chapter ID.

Once the machine learning model has been trained, any then-current set of signals (e.g., including all or some of the aforementioned input signals 502) may be presented to the machine learning model to generate one or more outputs (e.g., interest predictions 504). As shown, the outputs comprise values that can be used, individually or in combination, to instruct the CMS to take some particular action, and/or to form a recommendation. As one example, an output of the machine learning model might include a user-specific fine-grained recommendation 107, and/or an interest attenuation value 530, and/or an interest amplification value 532, and/or a list of other interested users 534, etc. In some embodiments the machine learning model is configured to output a recommended workflow task 536 and/or a recommended workflow entry point 538. More particularly, one or both of such a recommended workflow task 536 and/or such a recommended workflow entry point 538 can correspond to the concurrently output user-specific fine-grained recommendations 107.

Further details regarding general approaches to triggering workflows are described in U.S. application Ser. No. 17/447,559 titled “BROKER-ASSISTED WORKFLOWS” filed on Sep. 13, 2021, which is hereby incorporated by reference in its entirety.

A CMS system that infers interest and emits recommendations therefrom offers great utility to users. Many hundreds of man hours can be saved and/or many unintended omissions can be avoided through application of the herein-disclosed recommendation system.

### Additional Embodiments of the Disclosure

### Instruction Code Examples

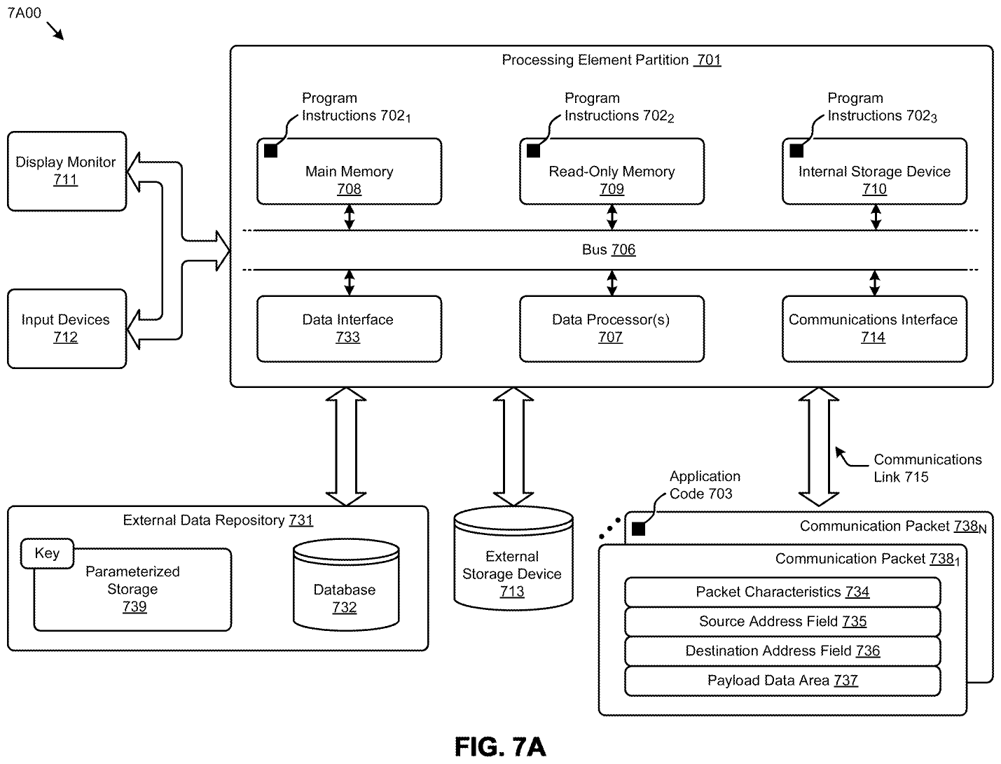

FIG. 6A depicts a system 6A00 as an arrangement of computing modules that are interconnected so as to operate cooperatively to implement certain of the herein-disclosed embodiments. This and other embodiments present particular arrangements of elements that, individually or as combined, serve to form improved technological processes that address failure of legacy recommendation systems to consider logical sub-parts of files when making recommendations. The partitioning of system 6A00 is merely illustrative and other partitions are possible. As an option, the system 6A00 may be implemented in the context of the architecture and functionality of the embodiments described herein. Of course, however, the system 6A00 or any operation therein may be carried out in any desired environment.

The system 6A00 comprises at least one processor and at least one memory, the memory serving to store program instructions corresponding to the operations of the system. As shown, an operation can be implemented in whole or in part using program instructions accessible by a module. The modules are connected to a communication path 6A05, and any operation can communicate with any other operations over communication path 6A05. The modules of the system can, individually or in combination, perform method operations within system 6A00. Any operations performed within system 6A00 may be performed in any order unless as may be specified in the claims.

The shown embodiment implements a portion of a computer system, presented as system 6A00, comprising one or more computer processors to execute a set of program code instructions (module 6A10) and modules for accessing memory to hold program code instructions to perform: interfacing a recommendation system to a content management system (CMS) that stores instances of shared content objects and coordinates user interactions by and between a plurality of CMS users (module 6A20); dividing one or more of the shared content objects into a plurality of portions (module 6A30); observing user interactions of a first CMS user over at least one content object of the plurality of the shared content objects, wherein at least some of the user interactions correspond to a particular portion of the at least one content object (module 6A40); drawing one or more user interest inferences based at least in part on the user interactions of the first CMS user over the particular portion of the at least one content object (module 6A50); forming a fine-grained recommendation that refers to the particular portion of the at least one content object wherein the fine-grained recommendation refers to the particular portion of the content object as well as the content object itself (module 6A60); and providing the fine-grained recommendation to a second CMS user (module 6A70).

Variations of the foregoing may include more or fewer of the shown modules. Certain variations may perform more or fewer (or different) steps and/or certain variations may use data elements in more, or in fewer, or in different operations. Still further, some embodiments include variations in the operations performed, and some embodiments include variations of aspects of the data elements used in the operations.

FIG. 6B depicts a system 6B00 as an arrangement of computing modules that are interconnected so as to operate cooperatively to implement certain of the herein-disclosed embodiments. The partitioning of system 6B00 is merely illustrative and other partitions are possible. As an option, the system 6B00 may be implemented in the context of the architecture and functionality of the embodiments described herein. Of course, however, the system 6B00 or any operation therein may be carried out in any desired environment.

The system 6B00 comprises at least one processor and at least one memory, the memory serving to store program instructions corresponding to the operations of the system. As shown, an operation can be implemented in whole or in part using program instructions accessible by a module. The modules are connected to a communication path 6B05, and any operation can communicate with any other operations over communication path 6B05. The modules of the system can, individually or in combination, perform method operations within system 6B00. Any operations performed within system 6B00 may be performed in any order unless as may be specified in the claims.

The shown embodiment implements a portion of a computer system, presented as system 6B00, comprising one or more computer processors to execute a set of program code instructions (module 6B10) and modules for accessing memory to hold program code instructions to perform: interfacing a recommendation system to a content management system (CMS) that stores instances of shared content objects and coordinates user interactions by and between a plurality of CMS users (module 6B20); dividing one or more of the shared content objects into a plurality of portions (module 6B30); observing user interactions of a first CMS user over at least one first content object of the plurality of the shared content objects, wherein at least some of the user interactions correspond to a particular portion of the at least one first content object (module 6B40); drawing one or more user interest inferences based at least in part on the user interactions of the first CMS user over the particular portion of the at least one first content object (module 6B50); forming a fine-grained recommendation that refers a portion of at least one second content object wherein the fine-grained recommendation refers to the portion of the second content object as well as the second content object itself (module 6B60); and providing the fine-grained recommendation to the first CMS user (module 6B70).

In some embodiments the foregoing first content object is of a first type (e.g., a “DOCX” document containing lyrics from a musical), and the second content object is of a second type (e.g., an “MPEG4” file of a movie). Some embodiments include computer modules for determining one or more relationships between a first CMS user and a second CMS user and then providing, to the second CMS user, fine-grained recommendations that refer a particular portion of at least one second content object.

Variations of the foregoing may include more or fewer of the shown modules. Certain variations may perform more or fewer (or different) steps and/or certain variations may use data elements in more, or in fewer, or in different operations. Still further, some embodiments include variations in the operations performed, and some embodiments include variations of aspects of the data elements used in the operations.

FIG. 6C depicts a system 6C00 as an arrangement of computing modules that are interconnected so as to operate cooperatively to implement certain of the herein-disclosed embodiments. The partitioning of system 6C00 is merely illustrative and other partitions are possible. As an option, the system 6C00 may be implemented in the context of the architecture and functionality of the embodiments described herein. Of course, however, the system 6C00 or any operation therein may be carried out in any desired environment.

The system 6C00 comprises at least one processor and at least one memory, the memory serving to store program instructions corresponding to the operations of the system. As shown, an operation can be implemented in whole or in part using program instructions accessible by a module. The modules are connected to a communication path 6C05, and any operation can communicate with any other operations over communication path 6C05. The modules of the system can, individually or in combination, perform method operations within system 6C00. Any operations performed within system 6C00 may be performed in any order unless as may be specified in the claims.

The shown embodiment implements a portion of a computer system, presented as system 6C00, comprising one or more computer processors to execute a set of program code instructions (module 6C10) and modules for accessing memory to hold program code instructions to perform: interfacing a recommendation system to a content management system (CMS) that stores instances of shared files and coordinates user interactions with the shared files, the user interactions being by and between a plurality of CMS users (module 6C20); identifying two or more address ranges that correspond to two or more logical portions of a particular single file, the two or more address ranges defining locations within the particular single file (module 6C30) storing, onto a computer readable medium, a record of observed user device interactions of a first CMS user over the particular single file, wherein at least some of the observed user device interactions correspond to the first CMS user's interactions with a particular logical portion of the particular single file (module 6C40); using the record of observed user device interactions to compute a fine-grained recommendation that refers to the particular logical portion of the particular single file (module 6C50); and communicating, to at least some of the plurality of CMS users, the fine-grained recommendation, wherein the fine-grained recommendation refers to the particular logical portion of the particular single file as well as to the particular single file itself (module 6C60).

### Additional Practical Application Examples

The foregoing disclosure supports many variations. Specifically, though not in an limiting sense, the paragraphs hereunder provide still further variations. As one example variation, content objects can be added to the CMS via manual or automated upload, or by virtue of attachment of a content object to an email, or a content object can be provided at a web portal and/or synchronized from an application so as to continuously upload changes to the CMS system. In some cases a content object comports with predefined metadata that is associated with an uploaded content object.

The aforementioned location information can derive from application of any known technique. For example, location information could derive from manual input, and/or from templates, and/or from audio patterns (e.g., speech patterns, ambient sound patterns, video patterns, shape/image recognition, data pattern matching, etc.). Additionally or alternatively, a location could point to a section of a text document, or a location could correspond to a time offset in an audio or video file. In some embodiments, such patterns can be found in output from a computerized scan. Such scanning can include optical character recognition (OCR), which may in turn include word or phrase detection, audio/video/image scanning and pattern matching, identification of patterns that correspond to template overlays, etc. In some cases data pattern matching, possibly including machine learning models can be used to detect phraseology/meaning/intent, etc.

As used herein, the term “user” can refer to a natural person. Additionally or alternatively, a user can refer to an agent or a machine such as any type of machine-to-machine interface, and/or to a user proxy such as might be implemented via an application programming interface (API).

The CMS interfaces with user devices, and as such the CMS can track and collect user activity (e.g., content upload, download, create, delete, modify, content moves/renames, scrolling, paging, hovering, fast forwarding, pausing, etc.). Moreover, any one or more modules for activity tracking can be configured with the ability to process the collected information so as to reformat and/or normalize it into datasets that a machine learning system can ingest.

In some cases, a machine learning model is trained (e.g., using supervised learning techniques or unsupervised learning techniques) using actual user observations as training vectors. In some embodiments, rules-based mappings are applied to actual user observations so as to train and retrain dynamic/self-learning models for learning an interest of a user.

Certain example embodiments include a notification engine that combines user activity tracking data with pre-registered user interests. In some cases a notification engine is able to perform notification analytics that combine user activity data with CMS metadata. Some implementations of a notification engine can raise triggers to cause an event and/or emit a message and/or autonomously call an API. Such triggering can be based on matching then-current conditions to rules that are in turn fired to raise further triggers and/or events.

User interest tags are extensible. They can derive from a user directly (e.g., by user specification), or they can be processed through a filter so as to canonize tags. In some cases user interest tags are formed in response to outputs from notification analytics modules. For example, a newly formed user interest tag might be based on observed user interactions having to do with previous related or similar content object interactions. In some cases, a newly formed user interest tag might be based outputs of a machine learning model and/or might be based on recommendations that had been propagated to a user in the form of notifications. In some cases, user interest tags can derive from user group associations (e.g., collab groups), and/or from peer reviews, and/or from legal reviews, and/or from cohorts, etc.)

Notifications contain a significant amount of information that is communicated to a subject user. For example, a notification can contain not only one or more recommendations, but can also contain contextual information pertaining to the one or more recommendations. Such contextual information may include historical information about the content object, a journal of who performed what actions on the content object, as well as user-specific recommendations of what types of actions are recommended to the user to take over the content object (e.g., review/edit a section, add a section, etc.). In some cases a notification can refer to previous notifications and/or notification rules (e.g., notification rules that triggered the notification) and/or a notification can contain analysis that includes trends (e.g., trends pertaining to the subject matter of the recommendations, trends that pertain to the content and/or frequency of notifications, etc.).

One or more notification analytics modules can be configured to collect information related to analytics of any event or events in the CMS. To facilitate such data collection, various instrumentation may be added to the CMS so as to track additions of and/or changes to metadata of the CMS. Such notification analytics modules can use the collected information to further train machine learning models (e.g., to adjust the importance level of interest tags, and or to adjust the semantics of notification rules, etc.) Results from any one or more of the aforementioned notification analytics modules can be exported in formats that can in turn be used for historical tracking, ingestion into an analytics database (e.g., into a data lake, into a data warehouse, etc.), and/or for ongoing development of the notification analytics modules, and/or for ongoing training of the machine learning systems of the CMS, and/or for ongoing training of the machine learning systems of the recommendation system.

### System Architecture Overview

### Additional System Architecture Examples

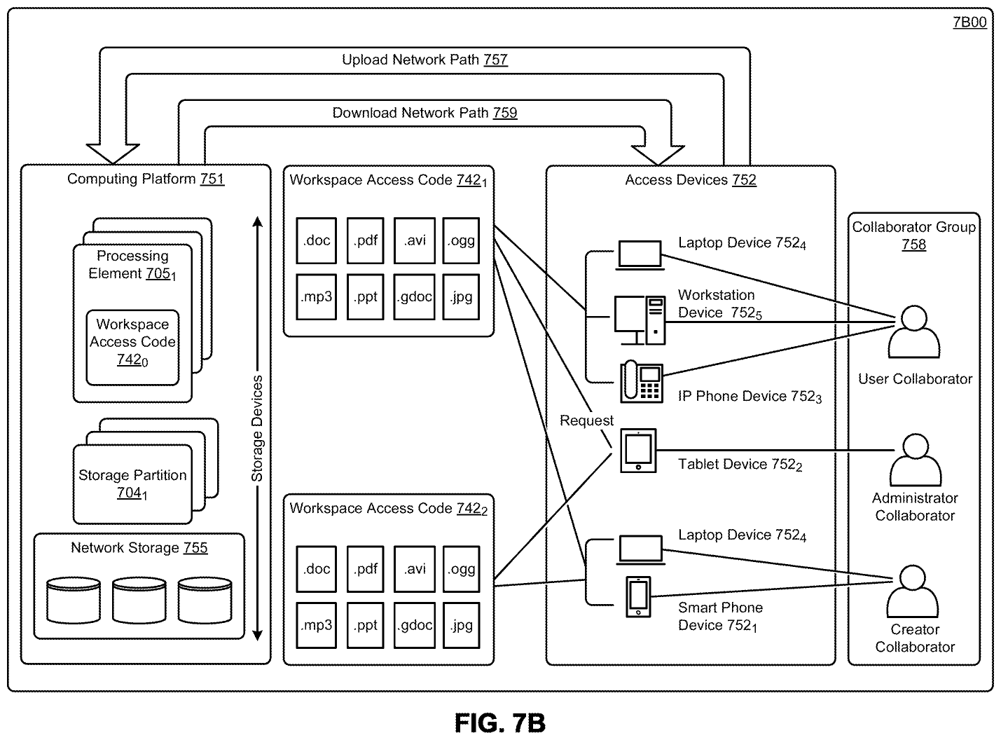

FIG. 7A depicts a block diagram of an instance of a computer system 7A00 suitable for implementing embodiments of the present disclosure. Computer system 7A00 includes a bus 706 or other communication mechanism for communicating information. The bus interconnects subsystems and devices such as a central processing unit (CPU), or a multi-core CPU (e.g., data processor 707), a system memory (e.g., main memory 708, or an area of random access memory (RAM)), a non-volatile storage device or non-volatile storage area (e.g., read-only memory 709), an internal storage device 710 or external storage device 713 (e.g., magnetic or optical), a data interface 733, a communications interface 714 (e.g., PHY, MAC, Ethernet interface, modem, etc.). The aforementioned components are shown within processing element partition 701, however other partitions are possible. Computer system 7A00 further comprises a display 711 (e.g., CRT or LCD), various input devices 712 (e.g., keyboard, cursor control), and an external data repository 731.

According to an embodiment of the disclosure, computer system 7A00 performs specific operations by data processor 707 executing one or more sequences of one or more program instructions contained in a memory. Such instructions (e.g., program instructions 702₁, program instructions 702₂, program instructions 702₃, etc.) can be contained in or can be read into a storage location or memory from any computer readable/usable storage medium such as a static storage device or a disk drive. The sequences can be organized to be accessed by one or more processing entities configured to execute a single process or configured to execute multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

According to an embodiment of the disclosure, computer system 7A00 performs specific networking operations using one or more instances of communications interface 714. Instances of communications interface 714 may comprise one or more networking ports that are configurable (e.g., pertaining to speed, protocol, physical layer characteristics, media access characteristics, etc.) and any particular instance of communications interface 714 or port thereto can be configured differently from any other particular instance. Portions of a communication protocol can be carried out in whole or in part by any instance of communications interface 714, and data (e.g., packets, data structures, bit fields, etc.) can be positioned in storage locations within communications interface 714, or within system memory, and such data can be accessed (e.g., using random access addressing, or using direct memory access DMA, etc.) by devices such as data processor 707.

Communications link 715 can be configured to transmit (e.g., send, receive, signal, etc.) any types of communications packets (e.g., communication packet 738₁, communication packet 738_{N}) comprising any organization of data items. The data items can comprise a payload data area 737, a destination address 736 (e.g., a destination IP address), a source address 735 (e.g., a source IP address), and can include various encodings or formatting of bit fields to populate packet characteristics 734. In some cases, the packet characteristics include a version identifier, a packet or payload length, a traffic class, a flow label, etc. In some cases, payload data area 737 comprises a data structure that is encoded and/or formatted to fit into byte or word boundaries of the packet.

In some embodiments, hard-wired circuitry may be used in place of or in combination with software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

The term “computer readable medium” or “computer usable medium” as used herein refers to any medium that participates in providing instructions to data processor 707 for execution. Such a medium may take many forms including, but not limited to, non-volatile media and volatile media. Non-volatile media includes, for example, optical or magnetic disks such as disk drives or tape drives. Volatile media includes dynamic memory such as RAM.

Common forms of computer readable media include, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory computer readable medium. Such data can be stored, for example, in any form of external data repository 731, which in turn can be formatted into any one or more storage areas, and which can comprise parameterized storage 739 accessible by a key (e.g., filename, table name, block address, offset address, etc.).

Execution of the sequences of instructions to practice certain embodiments of the disclosure are performed by a single instance of a computer system 7A00. According to certain embodiments of the disclosure, two or more instances of computer system 7A00 coupled by a communications link 715 (e.g., LAN, public switched telephone network, or wireless network) may perform the sequence of instructions required to practice embodiments of the disclosure using two or more instances of components of computer system 7A00.

Computer system 7A00 may transmit and receive messages such as data and/or instructions organized into a data structure (e.g., communications packets). The data structure can include program instructions (e.g., application code 703), communicated through communications link 715 and communications interface 714. Received program instructions may be executed by data processor 707 as it is received and/or stored in the shown storage device or in or upon any other non-volatile storage for later execution. Computer system 7A00 may communicate through a data interface 733 to a database 732 on an external data repository 731. Data items in a database can be accessed using a primary key (e.g., a relational database primary key).

Processing element partition 701 is merely one sample partition. Other partitions can include multiple data processors, and/or multiple communications interfaces, and/or multiple storage devices, etc. within a partition. For example, a partition can bound a multi-core processor (e.g., possibly including embedded or co-located memory), or a partition can bound a computing cluster having plurality of computing elements, any of which computing elements are connected directly or indirectly to a communications link. A first partition can be configured to communicate to a second partition. A particular first partition and particular second partition can be congruent (e.g., in a processing element array) or can be different (e.g., comprising disjoint sets of components).

A module as used herein can be implemented using any mix of any portions of the system memory and any extent of hard-wired circuitry including hard-wired circuitry embodied as a data processor 707. Some embodiments include one or more special-purpose hardware components (e.g., power control, logic, sensors, transducers, etc.). Some embodiments of a module include instructions that are stored in a memory for execution so as to facilitate operational and/or performance characteristics pertaining to generating fine-grained recommendations based on user interactions with content objects of a content management system. A module may include one or more state machines and/or combinational logic used to implement or facilitate the operational and/or performance characteristics pertaining to generating fine-grained recommendations based on user interactions with content objects of a content management system.

Various implementations of database 732 comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of generating fine-grained recommendations based on user interactions with content objects of a content management system). Such files, records, or data structures can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to generating fine-grained recommendations based on user interactions with content objects of a content management system, and/or for improving the way data is manipulated when performing computerized operations pertaining to considering the actual sub-parts of content objects and their corresponding locations when making recommendations.

FIG. 7B depicts a block diagram of an instance of a cloud-based environment 7B00. Such a cloud-based environment supports access to workspaces through the execution of workspace access code (e.g., workspace access code 742₀, workspace access code 742₁, and workspace access code 742₂). Workspace access code can be executed on any of access devices 752 (e.g., laptop device 752₄, workstation device 752₅, IP phone device 752₃, tablet device 752₂, smart phone device 752₁, etc.), and can be configured to access any type of object. Strictly as examples, such objects can be folders or directories or can be files of any filetype. The files or folders or directories can be organized into any hierarchy. Any type of object can comprise or be associated with access permissions. The access permissions in turn may correspond to different actions to be taken over the object. Strictly as one example, a first permission (e.g., PREVIEW_ONLY) may be associated with a first action (e.g., preview), while a second permission (e.g., READ) may be associated with a second action (e.g., download), etc. Furthermore, permissions may be associated to any particular user or any particular group of users.

A group of users can form a collaborator group 758, and a collaborator group can be composed of any types or roles of users. For example, and as shown, a collaborator group can comprise a user collaborator, an administrator collaborator, a creator collaborator, etc. Any user can use any one or more of the access devices, and such access devices can be operated concurrently to provide multiple concurrent sessions and/or other techniques to access workspaces through the workspace access code.

A portion of workspace access code can reside in and be executed on any access device. Any portion of the workspace access code can reside in and be executed on any computing platform 751, including in a middleware setting. As shown, a portion of the workspace access code resides in and can be executed on one or more processing elements (e.g., processing element 705₁). The workspace access code can interface with storage devices such as networked storage 755. Storage of workspaces and/or any constituent files or objects, and/or any other code or scripts or data can be stored in any one or more storage partitions (e.g., storage partition 704₁). In some environments, a processing element includes forms of storage, such as RAM and/or ROM and/or FLASH, and/or other forms of volatile and non-volatile storage.

A stored workspace can be populated via an upload (e.g., an upload from an access device to a processing element over an upload network path 757). A stored workspace can be delivered to a particular user and/or shared with other particular users via a download (e.g., a download from a processing element to an access device over a download network path 759).

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A method comprising:
interfacing a recommendation system to a content management system (CMS) that stores instances of shared files and coordinates user interactions with the shared files, the user interactions being by and between a plurality of CMS users;
identifying two or more address ranges that correspond to two or more logical portions of a particular single file, the two or more address ranges defining locations within the particular single file;
storing, onto a computer readable medium, a record of observed user device interactions of a first CMS user over the particular single file, wherein at least some of the observed user device interactions correspond to the first CMS user's interactions with a particular logical portion of the particular single file;
using the record of observed user device interactions to compute a fine-grained recommendation that refers to the particular logical portion of the particular single file; and
communicating, to at least some of the plurality of CMS users, the fine-grained recommendation, wherein the fine-grained recommendation refers to the particular logical portion of the particular single file as well as to the particular single file itself.

2. The method of claim 1, further comprising:
determining a second CMS user, wherein the second CMS user is associated with the first CMS user; and
providing the fine-grained recommendation to the second CMS user.

3. The method of claim 2, wherein determining the second CMS user comprises comparing at least one attribute of the first CMS user to at least one attribute of the second CMS user.

4. The method of claim 3, wherein the at least one attribute of the first CMS user comprises an inferred interest.

5. The method of claim 3, wherein the at least one attribute of the first CMS user comprises one or more user interactions.

6. The method of claim 2, wherein the first CMS user is associated with the second CMS based at least in part on at least one of, the first CMS user's interactions or the second CMS user's interactions.

7. The method of claim 1, further comprising:
capturing user interaction events of the first CMS user in response to a notification; and
using the user interaction events of the first CMS user's response to the notification to train or adjust a machine learning model.

8. The method of claim 1, further comprising learning an interest of the first CMS user based on the first CMS user's interactions over the particular portion of the particular single file.

9. The method of claim 8, wherein the first CMS user's interactions over the portion of the particular single file is at least one of, a mouse hover, a rewind command, or a pause command.

10. The method of claim 1, wherein the fine-grained recommendation is a suggestion to a second CMS user to access a particular location of the particular single file, and wherein the second CMS user is selected based on a commonality or association between the first CMS user and the second CMS user.

11. The method of claim 10, wherein the fine-grained recommendation to the second CMS user is a topic-based recommendation to access the particular single file at a particular location.

12. The method of claim 11, wherein the topic-based recommendation to access a second single file at the particular location is based at least in part on one or more user attributes of the first user.

13. The method of claim 1, wherein the fine-grained recommendation that refers to the particular logical portion of the particular single file is based at least in part on one or more user attributes of a second user.

14. The method of claim 1, further comprising:
initiating an action on behalf of the first user, wherein the action is based on the fine-grained recommendation.

15. The method of claim 14, wherein the action on behalf of the first user is at least one of, an open operation, or a scrolling action.

16. The method of claim 1, wherein particular portion corresponds to at least one of, a section heading, a passage, a chapter, or a timecode.

17. A non-transitory computer readable medium having stored thereon a sequence of instructions which, when stored in memory and executed by one or more processors causes the one or more processors to perform a set of acts, the set of acts comprising:
interfacing a recommendation system to a content management system (CMS) that stores shared files and coordinates user interactions with the shared files, the user interactions being by and between a plurality of CMS users;
identifying two or more address ranges that correspond to two or more logical portions of a particular single file, the two or more address ranges defining locations within the particular single file;
storing, onto a computer readable medium, a record of observed user device interactions of a first CMS user over the particular single file, wherein at least some of the observed user device interactions correspond to the first CMS user's interactions with a particular logical portion of the particular single file;
using the record of observed user device interactions to compute a fine-grained recommendation that refers to the particular logical portion of the particular single file; and
communicating, to at least some of the plurality of CMS users, the fine-grained recommendation, wherein the fine-grained recommendation refers to the particular logical portion of the particular single file as well as to the particular single file itself.

18. The non-transitory computer readable medium of claim 17, further comprising instructions which, when stored in memory and executed by the one or more processors causes the one or more processors to perform acts of:
determining a second CMS user, wherein the second CMS user is associated with the first CMS user; and
providing the fine-grained recommendation to the second CMS user.

19. A system comprising:
a storage medium having stored thereon a sequence of instructions; and
one or more processors that execute the sequence of instructions to cause the one or more processors to perform a set of acts, the set of acts comprising,
interfacing a recommendation system to a content management system (CMS) that stores shared files and coordinates user interactions with the shared files, the user interactions being by and between a plurality of CMS users;
identifying two or more address ranges that correspond to two or more logical portions of a particular single file, the two or more address ranges defining locations within the particular single file;
storing, onto a computer readable medium, a record of observed user device interactions of a first CMS user over the particular single file, wherein at least some of the observed user device interactions correspond to the first CMS user's interactions with a particular logical portion of the particular single file;
using the record of observed user device interactions to compute a fine-grained recommendation that refers to the particular logical portion of the particular single file; and
communicating, to at least some of the plurality of CMS users, the fine-grained recommendation, wherein the fine-grained recommendation refers to the particular logical portion of the particular single file as well as to the particular single file itself.

20. The system of claim 19, further comprising:
determining a second CMS user, wherein the second CMS user is associated with the first CMS user; and
providing the fine-grained recommendation to the second CMS user.
